(19) United States
(12) Patent Application Publication
(10) Pub. No.: US 2009/0278993 A1
(43) Pub. Date: Nov. 12, 2009

(54) Wireless Transmission System for Wirelessly Connecting Signal Source Apparatus And Signal Sink Apparatus

(75) Inventors: Yoshikane Nishikawa, Hyogo (JP); Toshio Sikimura, Osaka (JP); Makoto Funabiki, Osaka (JP); Akihiro Tatsuta, Kyoto (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, Osaka (JP)

(21) Appl. No.: 12/088,804

(22) PCT Filed: Oct. 2, 2006
(86) PCT No.: PCT/JP2006/319700

§ 371 Date: Jun. 20, 2008

(30) Foreign Application Priority Data
Sep. 30, 2005 (JP) 2005-287130

(51) Int. Cl. H04N 5/38; H04B 7/00

(52) U.S. Cl. 348/723; 455/68; 348/E05.093

(57) ABSTRACT

In an adapter apparatus, a wireless communication circuit wirelessly transmits an audio-visual signal to an adapter apparatus, and receives an HPD pulse signal from the adapter apparatus. A controller controls a DVD player to execute a predetermined initialization processing, by converting the HPD pulse signal into an HPD signal and outputting the HPD signal to the DVD player. In the adapter apparatus, a wireless communication circuit receives the audio-visual signal from the adapter apparatus, and wirelessly transmits the HPD pulse signal to the adapter apparatus. A controller controls the DVD player to execute the predetermined initialization processing, by controlling the wireless communication circuit to wirelessly transmit the HPD pulse signal to the adapter apparatus.

### TECHNICAL FIELD

The present invention relates to a wireless communication apparatus and a wireless transmission system. In particular, the present invention relates to a wireless communication apparatus and a wireless transmission system for wirelessly transmitting a video signal and an audio signal outputted from a signal source apparatus, such as a DVD player, a set-top box or the like, to a signal sink apparatus, such as a digital television or the like.

### BACKGROUND ART

Conventionally, there is known a DVI (Digital Visual Interface) standard as an interface standard for transmitting a video signal from a signal source apparatus, such as a DVD player or the like, to a signal sink apparatus, such as a plasma display panel apparatus (referred to as a PDP apparatus hereinafter) or the like. Since data transmitted via a DVI cable of a digital data transmission bus compliant with the DVI standard is digital data, the digital data transmission is advantageous over the analog data transmission in that the noise resistance is large and that the image quality can be mage high. In addition, in a DVI system according to a prior art constituted by including a DVI source apparatus and a DVI sink apparatus, the DVI source apparatus and the DVI sink apparatus are connected to each other via the DVI cable and an audio cable for transmitting an audio signal. In this case, the DVI source apparatus is a signal source apparatus, such as a DVD player, a set-top box or the like, for transmitting and receiving signals compliant with the DVI standard. The DVI sink apparatus is a signal sink apparatus, such as a liquid crystal display apparatus, a digital television apparatus or the like, for transmitting and receiving signals compliant with the DVI standard. Further, according to the DVI standard, not only the video signal but also an HPD (Hot Plug Detect) signal and a control signal such as a 5V-voltage signal are transmitted. In this case, the HPD signal is an initialization signal transmitted from the signal sink apparatus to the signal source apparatus in order to initialize the signal source apparatus, and the 5V-voltage signal is a signal indicating a timing of supplying power from the signal source apparatus to the signal sink apparatus.

As an interface standard extended from the DVI standard for next-generation digital televisions, an HDMI (High Definition Multimedia Interface) standard for transmitting the video signal and the audio signal using one cable has been recently developed, and AV apparatuses adopting the HDMI standard are gradually commercially available. In an HDMI system according to a prior art constituted by including an HDMI source apparatus and an HDMI sink apparatus, the HDMI source apparatus and the HDMI sink apparatus are connected to each other via one HDMI cable of a digital data transmission bus compliant with the HDMI standard. In this case, the HDMI source apparatus is a signal source apparatus, such as a DVD player, a set-top box or the like, for transmitting and receiving signals compliant with the HDMI standard. The HDMI sink apparatus is a signal sink apparatus, such as a liquid crystal display apparatus, a digital television apparatus or the like, for transmitting and receiving signals compliant with the HDMI standard. Accordingly, the HDMI system is advantageous over the DVI system which requires a plurality of cables to transmit the video signal and the audio signal in that interconnection between AV apparatuses can be simplified. In addition, according to the HDVI standard, similarly to the DVI standard, not only the video signal and the audio signal but also the HPD signal and the control signal such as the 5V-voltage signal or the like are transmitted. Further, a conversion connector for connecting a DVI terminal of a data terminal compliant with the DVI standard, to an HDMI terminal of a data terminal compliant with the HDMI standard, are commercially available. Using the conversion connector, the HDMI source apparatus can be connected to the DVI sink apparatus, or the DVI source apparatus can be connected to the HDMI sink apparatus. The HDMI standard includes the DVI standard.

In addition, Patent Document 1 discloses a transmission system for transmitting a video signal and an audio signal by optical wireless communication.

Patent Document 1: Japanese patent laid-open publication No. JP-2005-102161-A.

### DISCLOSURE OF THE INVENTION

### Problems to be Solved by the Invention

However, the DVI system and the HDMI system according to the prior arts have the following problems. When the signal source apparatus is a wall-hung type television apparatus or a projector apparatus attached to the ceiling, it is required to wire the DVI cable and the audio cable or the HDMI cable along the wall to connect the signal source apparatus to the signal sink apparatus, and this leads to an extra effort and unsightly appearance. Further, the installation location and the handling range of the apparatuses are disadvantageously restricted by the lengths of the DVI cable and the audio cable or the HDMI cable for connecting the apparatuses to each other. Further, it is difficult for a user unaccustomed to the operation of the AV apparatuses to correctly connect a plurality of AV apparatuses to each other using the cables.

In addition, the Patent Document 1 discloses the transmission system for transmitting the video signal and the audio signal by the optical wireless communication, however, it is required to connect the AV apparatuses to each other using cables for transmitting the HPD signal and the control signal such as the 5V-voltage signal or the like. Accordingly, the transmission system has problems to similar those of the DVI system and the HDMI system according to the prior art.

An essential object of the present invention is to provide a wireless communication apparatus and a wireless transmission system capable of solving the foregoing problem, enhancing the flexibility of the installation locations of the signal source apparatus and the signal sink apparatus, and simplifying the connection between the signal source apparatus and the signal sink apparatus without using cables as compared with the prior arts.

### Means for Solving the Problems

According to a first aspect of the present invention, there is provided a wireless communication apparatus of a first wireless communication apparatus for transmitting a first signal including at least a video signal received from a signal source apparatus, and for receiving a second signal including a first initialization signal. The wireless communication apparatus includes first wireless communication means and first control means. The first wireless communication means wirelessly transmits the first signal to a second wireless communication apparatus as a first radio signal, and receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus.

In the above-mentioned wireless communication apparatus, upon detecting a communication failure between the first wireless communication apparatus and the second wireless communication apparatus, the first control means generates a request signal for requesting generation of the second radio signal including the first initialization signal, and controls the first wireless communication means to wirelessly transmit the request signal to the second wireless communication apparatus.

In addition, in the above-mentioned wireless communication apparatus, the first control means controls a signal sink apparatus connected to the second wireless communication apparatus to execute a predetermined second initialization processing, by controlling the first wireless communication means to wirelessly transmit a third radio signal including a second initialization signal to the second wireless communication apparatus.

Further, in the above-mentioned wireless communication apparatus, the first control means outputs the first initialization signal to the signal source apparatus after controlling the first wireless communication means to wirelessly transmit the third radio signal to the second wireless communication apparatus.

Still further, in the above-mentioned wireless communication apparatus, the first signal includes an audio signal in addition to the video signal. The video signal, the audio signal, the first initialization signal, and transmission procedures therefor are compliant with an HDMI (High Definition Multimedia Interface) standard.

In addition, in the above-mentioned wireless communication apparatus, the video signal, the first initialization signal, and transmission procedures therefor are compliant with a DVI (Digital Visual Interface) standard.

According to a second aspect of the present invention, there is provided a wireless communication apparatus of a second wireless communication apparatus for receiving a first signal including at least a video signal, and for transmitting a second signal including a first initialization signal. The wireless communication apparatus includes second wireless communication means and second control means. The second wireless communication means receives a first radio signal including the first signal from a first wireless communication apparatus, and wirelessly transmits the first initialization signal to the first wireless communication apparatus as a second radio signal. The second control means controls a signal source apparatus connected to the first wireless communication apparatus to execute a predetermined first initialization processing, by controlling the second wireless communication means to wirelessly transmit the first initialization signal to the first wireless communication apparatus as the second radio signal.

In the above-mentioned wireless communication apparatus, upon detecting a communication failure between the first wireless communication apparatus and the second wireless communication apparatus, the second control means controls the second wireless communication means to wirelessly transmit the first initialization signal to the first wireless communication apparatus as the second radio signal.

In addition, in the above-mentioned wireless communication apparatus the second wireless communication apparatus is connected to a signal sink apparatus. Upon detecting the communication failure between the first wireless communication apparatus and the second wireless communication apparatus, the second control means generates a non-image silent signal having predetermined specifications and outputs the non-image silent signal to the signal sink apparatus.

Further, in the above-mentioned wireless communication apparatus, in response to a request signal transmitted from the first wireless communication apparatus for requesting generation of the second radio signal including the first initialization signal, the second control means controls the second wireless communication means to wirelessly transmit the first initialization signal to the first wireless communication apparatus as the second radio signal.

Still further, in the above-mentioned wireless communication apparatus, the second wireless communication apparatus is connected to a signal sink apparatus. The second wireless communication apparatus receives a third radio signal including a second initialization signal from the first wireless communication apparatus. The second control means controls the signal sink apparatus to execute a predetermined second initialization processing, by converting the third radio signal into the second initialization signal and outputting the second initialization signal to the signal sink apparatus.

In addition, in the above-mentioned wireless communication apparatus, the second control means controls the second wireless communication means to wirelessly transmit the second radio signal including the first initialization signal to the first wireless communication apparatus after outputting the second initialization signal to the signal sink apparatus.

Further, in the above-mentioned wireless communication apparatus, the first signal includes an audio signal in addition to the video signal. The video signal, the audio signal, the first initialization signal, and transmission procedures therefor are compliant with an HDMI (High Definition Multimedia Interface) standard.

Still further, in the above-mentioned wireless communication apparatus, the video signal, the first initialization signal, and transmission procedures therefor are compliant with a DVI (Digital Visual Interface) standard.

According to a third aspect of the present invention, there is provided a wireless communication apparatus of a first wireless communication apparatus for transmitting a first signal including at least a video signal received from a signal source apparatus, and for receiving a second signal including a first initialization signal. The wireless communication apparatus includes first wireless communication means, second wireless communication means, and first control means. The first wireless communication means wirelessly transmits the first signal to a second wireless communication apparatus as a first radio signal. The second wireless communication means receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus.

In the above-mentioned wireless communication apparatus, upon detecting a communication failure between the first wireless communication apparatus and the second wireless communication apparatus, the first control means generates a request signal for requesting generation of the second radio signal including the first initialization signal and controls the second wireless communication means to wirelessly transmit the request signal to the second wireless communication apparatus.

In addition, in the above-mentioned wireless communication apparatus, the first control means controls a signal sink apparatus connected to the second wireless communication apparatus to execute a predetermined second initialization processing, by controlling the second wireless communication means to wirelessly transmit a third radio signal including a second initialization signal to the second wireless communication apparatus.

Further, in the above-mentioned wireless communication apparatus, the first control means outputs the first initialization signal to the signal source apparatus after controlling the second wireless communication means to wirelessly transmit the third radio signal to the second wireless communication apparatus.

Still further, in the above-mentioned wireless communication apparatus, the first signal includes an audio signal in addition to the video signal. The video signal, the audio signal, the first initialization signal, and transmission procedures therefor are compliant with an HDMI (High Definition Multimedia Interface) standard.

In addition, in the above-mentioned wireless communication apparatus, the video signal, the first initialization signal, and transmission procedures therefor are compliant with a DVI (Digital Visual Interface) standard.

According to a fourth aspect of the present invention, there is provided a wireless communication apparatus of a second wireless communication apparatus for receiving a first signal including at least a video signal, and for transmitting a second signal including a first initialization signal. The wireless communication apparatus includes third wireless communication means, fourth wireless communication means, and second control means. The third wireless communication means receives a first radio signal including the first signal from a first wireless communication apparatus. The fourth wireless communication means wirelessly transmits the first initialization signal to the first wireless communication apparatus as a second radio signal. The second control means controls a signal source apparatus connected to the first wireless communication apparatus to execute a predetermined first initialization processing, by controlling the fourth wireless communication means to wirelessly transmit the first initialization signal to the first wireless communication apparatus as the second radio signal.

In the above-mentioned wireless communication apparatus, upon detecting a communication failure between the first wireless communication apparatus and the second wireless communication apparatus, the second control means controls the fourth wireless communication means to wirelessly transmit the first initialization signal to the first wireless communication apparatus as the second radio signal.

In addition, in the above-mentioned wireless communication apparatus, the second wireless communication apparatus is connected to a signal sink apparatus. Upon detecting the communication failure between the first wireless communication apparatus and the second wireless communication apparatus, the second control means generates a non-image silent signal having predetermined specifications and outputs the non-image silent signal to the signal sink apparatus.

Further, in the above-mentioned wireless communication apparatus, in response to a request signal transmitted from the first wireless communication apparatus for requesting generation of the second radio signal including the first initialization signal, the second control means controls the fourth wireless communication means to wirelessly transmit the first initialization signal to the first wireless communication apparatus as the second radio signal.

Still further, in the above-mentioned wireless communication apparatus, the second wireless communication apparatus is connected to a signal sink apparatus. The fourth wireless communication means receives a third radio signal including a second initialization signal from the first wireless communication apparatus. The second control means controls the signal sink apparatus to execute a predetermined second initialization processing, by converting the third radio signal into the second initialization signal and outputting the second initialization signal to the signal sink apparatus.

In addition, in the above-mentioned wireless communication apparatus, the second control means controls the fourth wireless communication means to wirelessly transmit the second radio signal including the first initialization signal to the first wireless communication apparatus after outputting the second initialization signal to the signal sink apparatus.

Further, in the above-mentioned wireless communication apparatus, the first signal includes an audio signal in addition to the video signal. The video signal, the audio signal, the first initialization signal, and transmission procedures therefor are compliant with an HDMI (High Definition Multimedia Interface) standard.

Still further, in the above-mentioned wireless communication apparatus, the video signal, the first initialization signal, and transmission procedures therefor are compliant with a DVI (Digital Visual Interface) standard.

According to a fifth aspect of the present invention, there is provided a wireless transmission system including the above-mentioned first wireless communication apparatus according to the first aspect of the present invention and the above-mentioned second wireless communication apparatus according to the second aspect of the present invention.

According to a sixth aspect of the present invention, there is provided a wireless transmission system including the above-mentioned first wireless communication apparatus according to the third aspect of the present invention and the above-mentioned second wireless communication apparatus according to the fourth aspect of the present invention.

### EFFECTS OF THE INVENTION

The first wireless communication apparatus according to the first aspect of the present invention includes first wireless communication means and first control means. The first wireless communication means wirelessly transmits a first signal including at least a video signal received from a signal source apparatus to a second wireless communication apparatus as a first radio signal, and receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus. Accordingly, the first wireless communication apparatus can wirelessly transmit the first signal generated by the signal source apparatus, while wirelessly receiving the first initialization signal and outputting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus.

The second wireless communication apparatus according to the second aspect of the present invention includes second wireless communication means and second control means. The second wireless communication means receives a first radio signal including a first signal from the first wireless communication apparatus, and wirelessly transmits the first initialization signal to the first wireless communication apparatus as a second radio signal. The second control means controls a signal source apparatus connected to the first wireless communication apparatus to execute a predetermined first initialization processing, by controlling the second wireless communication means to wirelessly transmit the first initialization signal to the first wireless communication apparatus as the second radio signal. Accordingly, the second wireless communication apparatus can receive the first signal from the first wireless communication apparatus, while wirelessly receiving the first initialization signal to the first wireless communication apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal sink apparatus connected to the second wireless communication apparatus.

The first wireless communication apparatus according to the third aspect of the present invention includes first wireless communication means, second wireless communication means, and first control means. The first wireless communication means wirelessly transmits a first signal including at least a video signal received from a signal source apparatus, to the second wireless communication apparatus as a first radio signal. The second wireless communication means receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus. Accordingly, the first wireless communication apparatus can wirelessly transmit the first signal generated by the signal source apparatus, while wirelessly receiving the first initialization signal and outputting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus.

The second wireless communication apparatus according to the fourth aspect of the present invention includes third wireless communication means, fourth wireless communication means, and second control means. The third wireless communication means receives a first radio signal including the first signal from the first wireless communication apparatus. The fourth wireless communication means wirelessly transmits the first initialization signal to the first wireless communication apparatus as a second radio signal. The second control means controls a signal source apparatus connected to the first wireless communication apparatus to execute a predetermined first initialization processing, by controlling the fourth wireless communication means to wirelessly transmit the first initialization signal to the first wireless communication apparatus as the second radio signal. Accordingly, the second wireless communication apparatus can receive the first signal from the first wireless communication apparatus, while wirelessly receiving the first initialization signal to the first wireless communication apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal sink apparatus connected to the second wireless communication apparatus.

The wireless transmission system according to the fifth aspect of the invention includes the first wireless communication apparatus according to the first aspect of the invention, and the second wireless communication apparatus according to the second aspect of the invention. Accordingly, by connecting the first wireless communication apparatus to the signal source apparatus, and connecting the second wireless communication apparatus to the signal sink apparatus, it is possible to wirelessly transmit the first signal including at least the video signal generated by the signal sink apparatus to the signal sink apparatus, while wirelessly transmitting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus and installation location of the signal sink apparatus connected to the second wireless communication apparatus.

The wireless transmission system according to the sixth aspect of the invention includes the first wireless communication apparatus according to the third aspect of the invention, and the second wireless communication apparatus according to the fourth aspect of the invention. Accordingly, by connecting the first wireless communication apparatus to the signal source apparatus, and connecting the second wireless communication apparatus to the signal sink apparatus, it is possible to wirelessly transmit the first signal including at least the video signal generated by the signal sink apparatus to the signal sink apparatus, while wirelessly transmitting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus and installation location of the signal sink apparatus connected to the second wireless communication apparatus.

### BRIEF DESCRIPTION OF THE DRAWINGS

FIG. 1 is a block diagram showing a configuration of a wireless transmission system according to a first preferred embodiment of the present invention, including a DVD player 100, adapter apparatuses 200 and 300, and a PDP apparatus 400;

FIG. 2 is a sequence diagram showing a first operation example of the wireless transmission system shown in FIG. 1;

FIG. 3 is a sequence diagram showing a second operation example of the wireless transmission system shown in FIG. 1;

FIG. 4 is a sequence diagram showing a third operation example of the wireless transmission system shown in FIG. 1;

FIG. 5 is a sequence diagram showing a fourth operation example of the wireless transmission system shown in FIG. 1;

FIG. 6 is a sequence diagram showing a fifth operation example of the wireless transmission system shown in FIG. 1;

FIG. 7 shows a graph (a) showing a 5V-voltage signal generated by the DVD player 100 of FIG. 1 and outputted to the adapter apparatus 200, a graph (b) showing a 5V-pulse signal generated by the adapter apparatus 200 of FIG. 1 and wirelessly transmitted to the adapter apparatus 300 of FIG. 1, and a graph (c) showing a 5V-voltage signal generated by the adapter apparatus 300 of FIG. 1 and outputted to the PDP apparatus 400;

FIG. 8 shows a graph (a) showing an HPD signal generated by the PDP apparatus 400 of FIG. 1 and outputted to the adapter apparatus 300, a graph (b) showing an HPD pulse signal generated by the adapter apparatus 300 of FIG. 1 and wirelessly transmitted to the adapter apparatus 200, and a graph (c) showing an HPD signal generated by the adapter apparatus 200 of FIG. 1 and outputted to the DVD player 100;

FIG. 9 is a block diagram showing a configuration of a wireless transmission system according to a second preferred embodiment of the present invention, including the DVD player 100, adapter apparatuses 200A and 300A, and the PDP apparatus 400;

FIG. 10 is a block diagram showing a configuration of a wireless transmission system according to a third preferred embodiment of the present invention, including a DVD player 100A, adapter apparatuses 200B and 300B, and a PDP apparatus 400A; and

FIG. 11 is a block diagram showing a configuration of a wireless transmission system according to a fourth preferred embodiment of the present invention, including the DVD player 100A, adapter apparatuses 200C and 300C, and the PDP apparatus 400A.

### DESCRIPTION OF REFERENCE SYMBOLS

10, 50, 110, 410 . . . Controller,
11, 51, 111, 411 . . . CPU,
12, 52, 112, 412 . . . RAM,
13, 53, 113, 413 . . . ROM,
14, 54 114, 415 . . . Bus,
21, 21A, 57, 150, 150A, 450,450A . . . Interface,
22 . . . 5V-pulse signal generation circuit,
23 . . . HDP signal generation circuit,
24, 74 . . . Audio and visual signal processing circuit,
24A, 74A . . . Video signal processing circuit,
25, 25A, 25B, 27, 27A, 55, 55A, 55B, 57, 57A . . . Wireless communication circuit,
26, 28, 56, 58 . . . Antenna,
72 . . . 5V-voltage signal generation circuit,
73 . . . HPD pulse signal generation circuit,
75 . . . Non-image silent signal generation circuit,
75A . . . Non-image signal generation circuit,
100, 100A . . . DVD player,
101, 201, 301, 401 . . . HDMI terminal,
101A, 201A, 301A, 401A . . . DVI terminal,
102 . . . Loudspeaker,
120 . . . Decoder,
121, 453 . . . Audio signal processing circuit,
130 . . . DVD drive,
140 . . . DVD,
200, 200A, 200B, 200C, 300, 300A, 300B, 300C . . . Adapter apparatus,
400, 400A . . . PDP apparatus,
414 . . . EDID memory,
451 . . . Video signal processing circuit,
452 . . . Display,
454 . . . Loudspeaker,
501, 502 . . . HDMI cable, and
501A, 502A . . . DVI cable.

### BEST MODE FOR CARRYING OUT THE INVENTION

Embodiments according to the present invention will be described hereinafter with reference to the drawings. In addition, the same reference numerals are given to those similar to constitutional elements.

### First Preferred Embodiment

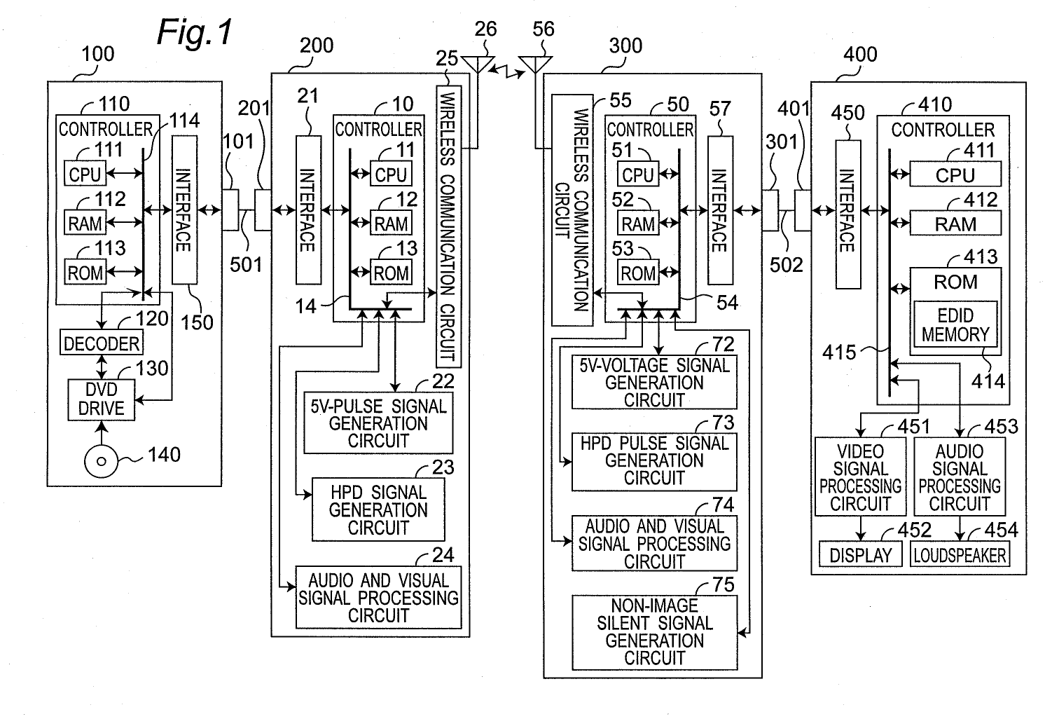

FIG. 1 is a block diagram showing a configuration of a wireless transmission system according to a first preferred embodiment of the present invention, including a DVD player 100, adapter apparatuses 200 and 300, and a PDP (Plasma Display Panel) apparatus 400. The wireless transmission system shown in FIG. 1 transmits an audio and visual signal and a 5V-voltage signal (or a +5V power signal) of a second initialization signal from the DVD player 100 to the PDP apparatus 400 via the adapter apparatuses 200 and 300. Further, the wireless transmission system shown in FIG. 1 transmits an HPD signal of a first initialization signal from the PDP apparatus 400 to the DVD player 100 via the adapter apparatuses 300 and 200.

In this case, the DVD player 100 is an HDMI source apparatus of a signal source apparatus for transmitting and receiving signals compliant with the HDMI standard. The DVD player 100 is connected to the adapter apparatus 200 via an HDMI terminal 101 of the DVD player 100, an HDMI cable 501, and an HDMI terminal 201 of the adapter apparatus 200. The PDP apparatus 400 is an HDMI sink apparatus of a signal sink apparatus for transmitting and receiving signals compliant with the HDMI standard. The PDP apparatus 400 is connected to the adapter apparatus 300 via an HDMI terminal 401 of the PDP apparatus 400, an HDMI cable 502, and an HDMI terminal 301 of the adapter apparatus 300. Further, the adapter apparatuses 200 and 300 are wirelessly connected to each other via an antenna 26 of the adapter apparatus 200 and an antenna 56 of the adapter apparatus 300.

The HDMI terminals 101, 201, 301 and 401 are data terminals compliant with the HDMI standard. The HDMI cables 501 and 502 are digital data transmission buses compliant with the HDMI standard. Each of the HDMI cables 501 and 502 includes a plurality of signal lines for transmitting the audio and visual signal, a 5V-voltage signal line for transmitting the 5V-voltage signal, and an HPD signal line for transmitting the HPD signal. The 5V-voltage signal is defined in the HDMI standard and the DVI standard, and provided for indicating a timing of supplying a power from the signal source apparatus to the signal sink apparatus. Further, the 5V-voltage signal is generated by the signal source apparatus such as the DVD player 100, and outputted to the signal sink apparatus such as the PDP apparatus 400. In response to the 5V-voltage signal, the signal sink apparatus executes a predetermined initialization processing. The HPD signal is defined in the HDMI standard and the DVI standard. Further, the HPD signal is an initialization signal transmitted from the signal sink apparatus to the signal source apparatus in order to initialize the signal source apparatus, when the signal sink apparatus receives the 5V-voltage signal and terminates the predetermined initialization processing, or when the signal sink apparatus transmits an initialization request to the signal source apparatus. The signal source apparatus determines whether or not the HPD signal has been received, by detecting a change in a voltage level of the HPD signal line of the HDMI cable or the DVI cable, and executes a predetermined initialization processing.

In this case, as will be described later in detail, the adapter apparatus 200 is characterized by including a wireless communication circuit 25 and a controller 10. The wireless communication circuit wirelessly transmits a first signal including the audio and visual signal received from the DVD player 100, to the adapter apparatus 300 as an audio and visual radio signal, and receives an HPD pulse signal including the HPD signal from the adapter apparatus 300. The controller 10 controls the DVD player 100 to execute the predetermined initialization processing, by converting the HPD pulse signal into the HPD signal and outputting the HPD signal to the DVD player 100. In addition, as will be described later, the adapter apparatus 300 is characterized by including a wireless communication circuit 55 and a controller 50. The wireless communication circuit 55 receives the audio and visual radio signal including the audio and visual signal from the adapter apparatus 200, and wirelessly transmits the HPD signal to the adapter apparatus 200 as the HPD pulse signal. The controller 50 controls the DVD player 100 connected to the adapter apparatus 200 to execute the predetermined initialization processing, by controlling the wireless communication circuit 55 to wirelessly transmit the HPD signal to the adapter apparatus 200 as the HPD pulse signal.

Referring to FIG. 1, the DVD player 100 is constituted by including a controller 110, a decoder 120, a DVD drive 130, a DVD 140, an interface 150, and the HDMI terminal 101. In this case, the controller 110, the decoder 120, the DVD drive 130, and the interface 150 are connected with each other via a bus 114.

In the DVD player 100, the controller 110 is provided for controlling entire operation performed by the DVD player 100, and is constituted by including a CPU (Central Processing Unit; referred to as a CPU hereinafter) 111, a RAM (Random Access Memory; referred to as a RAM hereinafter) 112, and a ROM (Read Only Memory; referred to as a ROM hereinafter) 113 connected with each other via the bus 114. The CPU 111 is a computer for controlling the entire operation performed by the DVD player 100, and executes various software programs and the like. The ROM 113 preliminarily stores a program executable by a computer, for various kinds of software required for operating the DVD player 100 and software executed by the CPU 111. Further, the RAM 112 is made of an SRAM, a DRAM, an SDRAM or the like, used as a working area of the CPU 111, and stores temporary data generated upon executing the programs.

Further, in the DVD player 100, the interface 150 executes an interface processing for interfacing with the adapter apparatus 200 on an inputted signal, generates a signal and data compliant with the HDMI standard, and outputs the generated signal and data to the adapter apparatus 200 via the HDMI connector 101, the HDMI cable 501 and the HDMI connector 201. In addition, the interface 150 receives a signal inputted from the adapter apparatus 200 via the HDMI connector 201, the HDMI cable 501, and the HDMI connector 101, executes a predetermined interface processing including signal conversion and protocol conversion on the received signal, and outputs the processed signal and data to the CPU 111.

In the DVD player 100, the operation of the decoder 120 is controlled by the CPU 111. The decoder 120 reproduces the contents stored in the DVD 140 using the DVD drive 130, generates the audio and visual signal, and outputs the audio and visual signal to the CPU 111. The CPU 111 outputs the inputted audio and visual signal to the adapter apparatus 200 via the interface 150, the HDMI terminal 101, the HDMI cable 501, and the HDMI terminal 201.

Referring to FIG. 1, the adapter apparatus 200 is constituted by including the HDMI terminal 201, a controller 10, an interface 21, a 5V-pulse signal generation circuit 22, an HPD signal generation circuit 23, an audio and visual signal processing circuit 24, and a wireless communication circuit 25 including an antenna 26 connected with each other via a bus 14 of the controller 10.

In the adapter apparatus 200, the controller 10 is provided for controlling entire operation performed by the adapter apparatus 200, and is constituted by including a CPU 11, a RAM 12, and a ROM 13 connected with each other via the bus 14. The CPU 11 is a computer for controlling the entire operation performed by the adapter apparatus 200, and executes various software programs and the like. The ROM 13 preliminary stores a program executable by a computer, for various kinds of software required for operating the adapter apparatus 200 and software executed by the CPU 11. The RAM 12 is made of an SRAM, a DRAM, an SDRAM or the like, used as a working area of the CPU 11, and stores temporary data generated upon executing the programs.

In addition, in the adapter apparatus 200, the 5V-pulse signal generation circuit 22 generates a 5V-pulse signal based on an inputted 5V-voltage signal, and outputs the 5V-pulse signal to the CPU 11 as will be described later in detail. The HPD signal generation circuit 23 generates the HPD signal based on an inputted HPD pulse signal, and outputs the HPD signal to the CPU 11 as will be described later in detail. The audio and visual signal processing circuit 24 executes a compression-coding processing on an inputted audio and visual signal according to a predetermined compression-coding method, and outputs the processed audio and visual signal to the CPU 11.

Further, in the adapter apparatus 200, the interface 21 executes an interface processing for interfacing with the DVD player 100, and outputs a signal and data compliant with the HDMI standard to the DVD player 100 via the HDMI connector 201, the HDMI cable 501, and the HDMI connector 101. Further, the interface 21 receives a signal inputted from the DVD player 100 via the HDMI connector 101, the HDMI cable 501, and the HDMI connector 201, executes a predetermined interface processing including signal conversion and protocol conversion on the signal, and outputs the processed signal to the CPU 11.

In the adapter apparatus 200, the wireless communication circuit 25 digitally modulates a radio carrier wave into the audio and visual radio signal using a predetermined digital modulation method according to an inputted audio and visual signal, executes a high-frequency signal processing such as high frequency conversion and high frequency amplification on the audio and visual radio signal, and wirelessly transmits the processed audio and visual radio signal to the adapter apparatus 300 via the antenna 26. In addition, the wireless communication circuit 25 digitally modulates a radio carrier wave into radio signals using the predetermined digital modulation method according to the inputted 5V-pulse signal, an ACK signal, and an HDP pulse signal generation request signal to be described later in detail, executes the high frequency signal processing such as the high frequency conversion on the radio signals, and wirelessly transmits the processed radio signals to the adapter apparatus 300 via the antenna 26. Further, the wireless communication circuit 25 executes a high frequency signal processing such as low frequency conversion and high frequency amplification on a radio signal received via the antenna 26, demodulates the processed radio signal to a baseband signal using a predetermined digital demodulation method, converts the baseband signal into the HDP pulse signal or the ACK signal, and outputs the HDP pulse signal or the ACK signal to the CPU 11. In this way, the wireless communication circuit 25 wirelessly transmits the inputted audio and visual signal, the 5V-pulse signal, the ACK signal, and the HPD pulse signal generation request signal to the adapter apparatus 300, and wirelessly receives the HPD pulse signal and the ACK signal from the adapter apparatus 300.

Referring to FIG. 1, the adapter apparatus 300 is constituted by including the HDMI terminal 301, a controller 50, an interface 57, a 5V-voltage signal generation circuit 72, an HPD pulse signal generation circuit 73, an audio and visual signal processing circuit 74, a non-image silent signal generation circuit 75, and a wireless communication circuit 55 including an antenna 56 connected with each other via a bus 54 of the controller 50.

In the adapter apparatus 300, the controller 50 is provided for controlling entire operation performed by the adapter apparatus 300, and is constituted by including a CPU 51, a RAM 52, and a ROM 53 connected with each other via the bus 54. The CPU 51 is a computer for controlling the entire operation performed by the adapter apparatus 300, and executes various software programs and the like. The ROM 53 preliminary stores a program executable by a computer, for various software required for operating the adapter apparatus 300 and software executed by the CPU 51. The RAM 52 is made of an SRAM, a DRAM, an SDRAM or the like, used as a working area of the CPU 51, and stores temporary data generated upon executing the programs.

In addition, in the adapter apparatus 300, the 5V-voltage signal generation circuit 72 generates the 5V-voltage signal based on an inputted 5V-pulse signal and outputs the 5V-voltage signal to the CPU 51 as will be described later in detail. The HPD pulse signal generation circuit 73 generates the HPD pulse signal based on an inputted HPD signal, and outputs the HPD pulse signal to the CPU 51 as will be described later in detail. The audio and visual signal processing circuit 74 executes a decoding processing on an inputted audio and visual signal according to a predetermined decoding method, and outputs the processed audio and visual signal to the CPU 51. The non-image silent signal generation circuit 75 generates a non-image silent signal including a black image signal and a silent signal each having predetermined specifications, and outputs the non-image silent signal to the CPU 51. In this case, the black image signal is a video signal where a value of a luminance signal is 10 h (hexadecimal notation) and a value of a color-difference signal is 80 h (hexadecimal notation). The silent signal is an audio signal where a sound volume value is 00 h (hexadecimal notation).

Further, in the adapter apparatus 300, the interface 57 executes an interface processing for interfacing with the PDP apparatus 400, and outputs a signal and data compliant with the HDMI standard to the PDP apparatus 400 via the HDMI connector 301, the HDMI cable 502, and the HDMI connector 401. Further, the interface 57 receives a signal inputted from the PDP apparatus 400 via the HDMI connector 401, the HDMI cable 502, and the HDMI connector 301, executes a predetermined interface processing including signal conversion and protocol conversion on the signal, and outputs the processed signal to the CPU 51.

In the adapter apparatus 300, the wireless communication circuit 55 digitally modulates a radio carrier wave into a radio signal using a predetermined digital modulation method according to an inputted HDP pulse signal and an inputted ACK signal to be described later, executes a high-frequency signal processing such as high frequency conversion and high frequency amplification on the radio signal, and wirelessly transmits the processed radio signal to the adapter apparatus 200 via the antenna 56. Further, the wireless communication circuit 55 executes a high frequency signal processing such as low frequency conversion and high frequency amplification on the audio and visual radio signal received via the antenna 56, demodulates the processed audio and visual radio signal to a baseband signal using a predetermined digital demodulation method, converts the baseband signal into the audio and visual signal, and outputs the audio and visual signal to the CPU 51. Further, the wireless communication circuit 55 executes the high frequency signal processing such as the low frequency conversion and the high frequency amplification on a radio signal received via the antenna 56, demodulates the processed radio signal to the baseband signal using the predetermined digital demodulation method, converts the baseband signal into the 5V-pulse signal, the HPD pulse signal generation request signal or the ACK signal, and outputs the 5V-pulse signal, the HPD pulse signal generation request signal or the ACK signal to the CPU 51. In this way, the wireless communication circuit 55 wirelessly transmits the inputted HPD pulse signal and the ACK signal to the adapter apparatus 200, and wirelessly receives the audio and visual signal, the 5V-pulse signal, the ACK signal, and the HPD pulse signal generation request signal from the adapter apparatus 200.

Referring to FIG. 1, the PDP apparatus 400 is constituted by including the HDMI terminal 401, a controller 410, an interface 450, a video signal processing circuit 451, a display 452, an audio signal processing circuit 453, and a loudspeaker 454. In this case, the controller 410, the interface 450, the video signal processing circuit 451, and the audio signal processing circuit 453 are connected with each other via a bus 415 of the controller 410.

In the PDP apparatus 400, the controller 410 is provided for controlling entire operation performed by the PDP apparatus 400, and constituted by including a CPU 411, a RAM 412, and a ROM 413 connected with each other via the bus 415. The CPU 411 is a computer for controlling the entire operation performed by the PDP apparatus 400, and executes various software programs and the like. The ROM 413 preliminary stores a program executable by a computer, for various kinds of software required for operating the PDP apparatus 400. In addition, the ROM 413 includes an EDID (Extended Display Identification Data; referred to as an EDID hereinafter) memory 414 which preliminarily stores data such as product information of the plasma display unit 200, a manufacturer name, a video encoding method (for example, RGB, YC_{B}C_{R} 4:4:4 or YC_{B}C_{R} 4:2:2), resolution, field frequency, video output specifications such as the number of scanning lines, and audio output specifications such as audio output sampling. Further, the RAM 412 is made of an SRAM, a DRAM, an SDRAM or the like, used as a working area of the CPU 411, and stores temporary data generated upon executing the programs.

In the PDP apparatus 400, the interface 450 executes an interface processing for interfacing with the adapter apparatus 300, and outputs a signal and data compliant with the HDMI standard to the adapter apparatus 300 via the HDMI connector 401, the HDMI cable 502, and the HDMI connector 301. Further, the interface 450 receives a signal inputted from the adapter apparatus 300 via the HDMI connector 301, the HDMI cable 502, and the HDMI connector 501, executes a predetermined interface processing including signal conversion and protocol conversion on the signal, and outputs the processed signal to the CPU 411.

In addition, in the PDP apparatus 400, the video signal processing circuit 451 converts an inputted video signal into a video display signal having predetermined specifications, outputs the same signal to the display 452, and displays the same signal thereon. Further, the audio signal processing circuit 453 converts an inputted digital audio signal into an analog audio signal, amplifies the analog audio signal, and outputs the amplified analog audio signal to the loudspeaker 454.

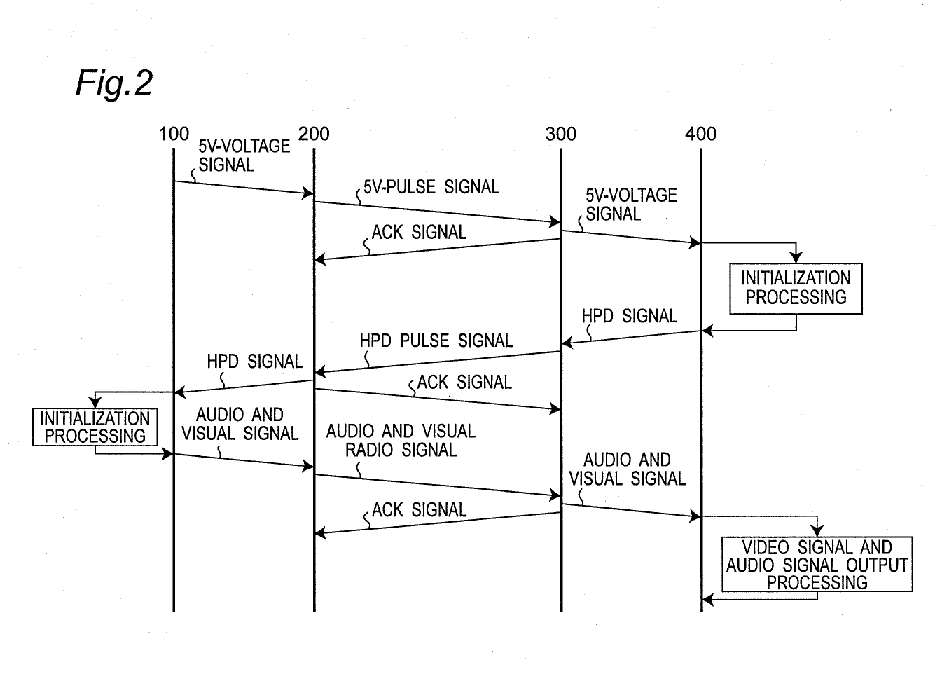

FIG. 2 is a sequence diagram showing a first operation example of the wireless transmission system shown in FIG. 1. Referring to FIG. 2, upon detecting that the adapter apparatus 200 in a power-ON state is connected to the DVD player 100 in the power-ON state, the CPU 111 of the DVD player 100 generates the 5V-voltage signal by changing the voltage level of the 5V-voltage signal line of the cable 501 from 0V to 5V, and outputs the 5V-voltage signal to the CPU 11 of the adapter apparatus 200. In response to this, the CPU 11 of the adapter apparatus 200 outputs the inputted 5V-voltage signal to the 5V-pulse signal generation circuit 22, and controls the 5V-pulse signal generation circuit 22 to generate the 5V-pulse signal, and to output the 5V-pulse signal to the CPU 11. In this case, the 5V-pulse signal rises at a timing of a rising edge of the 5V-voltage signal, and has a predetermined pulse width. Further, the CPU 11 wirelessly transmits the 5V-pulse signal inputted from the 5V-pulse signal generation circuit 22 to the CPU 51 of the adapter apparatus 300 via the antennas 26 and 56. Upon receiving the 5V-pulse signal normally, the CPU 51 of the adapter apparatus 300 outputs the received 5V-pulse signal to the 5V-voltage signal generation circuit 72. The, the CPU 51 controls the 5V-voltage signal generation circuit 72 to generate the 5V-voltage signal, whose level changes from 0V to 5V at the timing of the rising edge of the 5V-pulse signal, and to output the 5V-voltage signal to the CPU 51. The CPU 51 outputs the 5V-voltage signal to the CPU 411 of the PDP apparatus 400 by changing the voltage level of the 5V-voltage signal line of the HDMI cable 502 based on the 5V-voltage signal from the 5V-voltage signal generation circuit 72. Then, the CPU 51 generates an ACK signal indicating that the CPU 51 has received the 5V-pulse signal normally, and wirelessly transmits the ACK signal to the CPU 11 of the adapter apparatus 200 via the antennas 56 and 26. Upon receiving the ACK signal, the CPU 11 of the adapter apparatus 200 judges that the 5V-pulse signal has been normally transmitted to the CPU 51 of the adapter apparatus 300. Further, upon receiving the 5V-voltage signal, the CPU 411 of the PDP apparatus 400 executes the predetermined initialization processing compliant with the HDMI standard such as a processing for reading the EDID from the EDID memory 414.

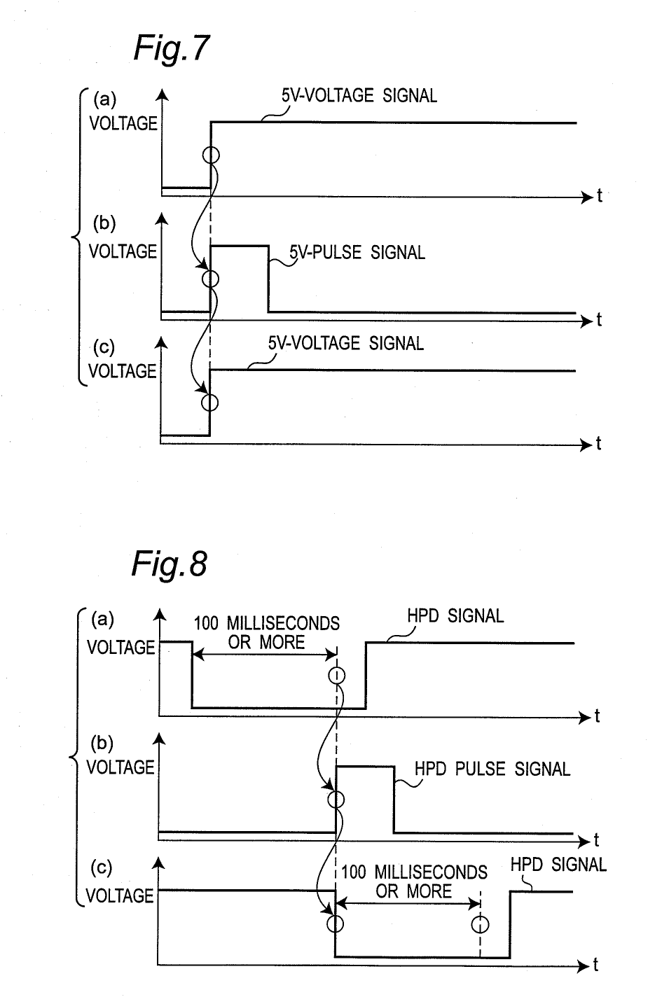

FIG. 7 shows a graph (a) showing the 5V-voltage signal generated by the DVD player 100 of FIG. 1 and outputted to the adapter apparatus 200 of FIG. 1, a graph (b) showing the 5V-pulse signal generated by the adapter apparatus 200 of FIG. 1 and wirelessly transmitted to the adapter apparatus 300 of FIG. 1, and a graph (c) showing the 5V-voltage signal generated by the adapter apparatus 300 of FIG. 1 and outputted to the PDP apparatus 400 of FIG. 1. As shown in FIG. 7, the 5V-voltage signal generated by the CPU 111 of the DVD player 100 is outputted to the CPU 11 of the adapter apparatus 200 via the HDMI cable 501, and the 5V-pulse signal generated by the 5V-pulse signal generation circuit 22 based on the 5V-voltage signal is wirelessly transmitted to the CPU 51 of the adapter apparatus 300. Further, the 5V-voltage signal generated by the 5V-voltage signal generation circuit 72 based on the 5V-pulse signal is outputted to the CPU 411 of the PDP apparatus 400 via the HDMI cable 502. In response to this, the CPU 411 of the PDP apparatus 400 can execute the predetermined initialization processing.

Referring back to FIG. 2, upon terminating the initialization processing, the CPU 411 of the PDP apparatus 400 generates the HPD signal by changing the voltage level of the HPD signal line of the HDMI cable 501 cable 502 from a high level to a low level and keeps the low level over a predetermined time interval equal to or more than 100 milliseconds, and outputs the HPD signal to the CPU 51 of the adapter apparatus 300. Upon detecting that the voltage level of the HPD signal line of the HDMI cable 502 has the low level over a time interval equal to or more than 100 milliseconds, the CPU 51 of the adapter apparatus 300 controls the HPD pulse signal generation circuit 73 to generate the HPD pulse signal and to output the HPD pulse signal to the CPU 51. In this case, HPD pulse signal rises at a timing until which the HDP signal having the low level has continued for 100 milliseconds, and has a predetermined pulse width. Further, the CPU 51 wirelessly transmits the HPD pulse signal inputted from the HPD pulse signal generation circuit 73 to the CPU 11 of the adapter apparatus 200 via the antennas 56 and 26. In response to this, upon receiving the HPD pulse signal normally, the CPU 11 of the adapter apparatus 200 outputs the received HPD pulse signal to the HPD signal generation circuit 23, and controls the HPD signal generation circuit 23 to generate the HPD signal whose level changes from the high level to the low level at a timing of a rising edge of the HPD pulse signal, and to output the HPD signal to the CPU 11. The CPU 11 outputs the HPD signal to the CPU 111 of the DVD player 100 by changing the voltage level of the HPD signal line of the HDMI cable 501 based on the HPD signal from the HPD signal generation circuit 23. Then, the CPU 11 generates an ACK signal indicating that the CPU 11 has received the HPD pulse signal normally, and wirelessly transmits the ACK signal to the CPU 51 of the adapter apparatus 300 via the antennas 26 and 56. Upon receiving the ACK signal, the CPU 51 of the adapter apparatus 300 judges that the HPD pulse signal has been normally transmitted to the CPU 11 of the adapter apparatus 200. Further, upon receiving the HPD signal, the CPU 111 of the DVD player 100 executes the predetermined initialization processing compliant with the HDMI standard.

FIG. 8 shows a graph (a) showing the HPD signal generated by the PDP apparatus 400 of FIG. 1 and outputted to the adapter apparatus 300 of FIG. 1, a graph (b) showing the HPD pulse signal generated by the adapter apparatus 300 of FIG. 1 and wirelessly transmitted to the adapter apparatus 200 of FIG. 1, and a graph (c) showing the HPD signal generated by the adapter apparatus 200 of FIG. 1 and outputted to the DVD player 100 of FIG. 1. As shown in FIG. 8, the HPD signal generated by the CPU 411 of the PDP apparatus 400 is outputted to the CPU 51 of the adapter apparatus 300 via the HDMI cable 502, and the HPD pulse signal generated by the HPD pulse signal generation circuit 73 based on the HPD signal is wirelessly transmitted to the CPU 11 of the adapter apparatus 200. Further, the HPD signal generated by the HPD signal generation circuit 23 based on the HPD pulse signal is outputted to the CPU 111 of the DVD player 100 via the HDMI cable 501. In response to this, the CPU 111 of the DVD player 100 can execute the predetermined initialization processing compliant with the HDMI standard.

Referring back to FIG. 2, upon terminating the initialization processing, the CPU 111 of the DVD player 100 controls the decoder 120 to reproduce the contents stored in the DVD 140, to generate the audio and visual signal, and to output the audio and visual signal to the CPU 111. In response to this, the decoder 120 reproduces the contents stored in the DVD 140 using the DVD drive 130, generates the audio and visual signal, and outputs the audio and visual signal to the CPU 111. The CPU 111 outputs the inputted audio and visual signal to the CPU 11 of the adapter apparatus 200. In response to this, the CPU 11 of the adapter apparatus 200 outputs the inputted audio and visual signal to the audio and visual signal processing circuit 24, and controls the audio and visual signal processing circuit 24 to execute the compression-coding processing on the audio and visual signal according to the predetermined compression-coding method, and to output the processed audio and visual signal to the CPU 11. Further, the CPU 11 wirelessly transmits the processed audio and visual signal to the CPU 51 of the adapter apparatus 300 as the audio and visual radio signal via the antennas 26 and 56. In response to this, the CPU 51 of the adapter apparatus 300 outputs the received audio and visual radio signal to the audio and visual signal processing circuit 74, and controls the audio and visual signal processing circuit 74 to execute the decoding processing on the audio and visual signal according to the predetermined decoding method, and to output the processed audio and visual signal to the CPU 51. The CPU 51 calculates a packet error rate (referred to as a PER hereinafter) of the processed audio and visual signal. When the PER is equal to or lower than a predetermined value, the CPU 51 judges that the CPU 51 has received the audio and visual signal normally, and outputs the processed audio and visual signal to the CPU 411 of the PDP apparatus 400. Then, the CPU 51 generates an ACK signal indicating that the CPU 51 has received the audio and visual signal normally, and wirelessly transmits the ACK signal to the CPU 11 of the adapter apparatus 200. Upon receiving the ACK signal, the CPU 11 of the adapter apparatus 200 judges that the audio and visual signal has been normally transmitted to the CPU 51 of the adapter apparatus 300. Further, the CPU 411 of the PDP apparatus 400 generates the video signal and the audio signal based on the inputted audio and visual signal, outputs the video signal to the display 452 via the video signal processing circuit 451 to display the video signal on the display 452, and outputs the audio signal to the loudspeaker 454 via the audio signal processing circuit 453.

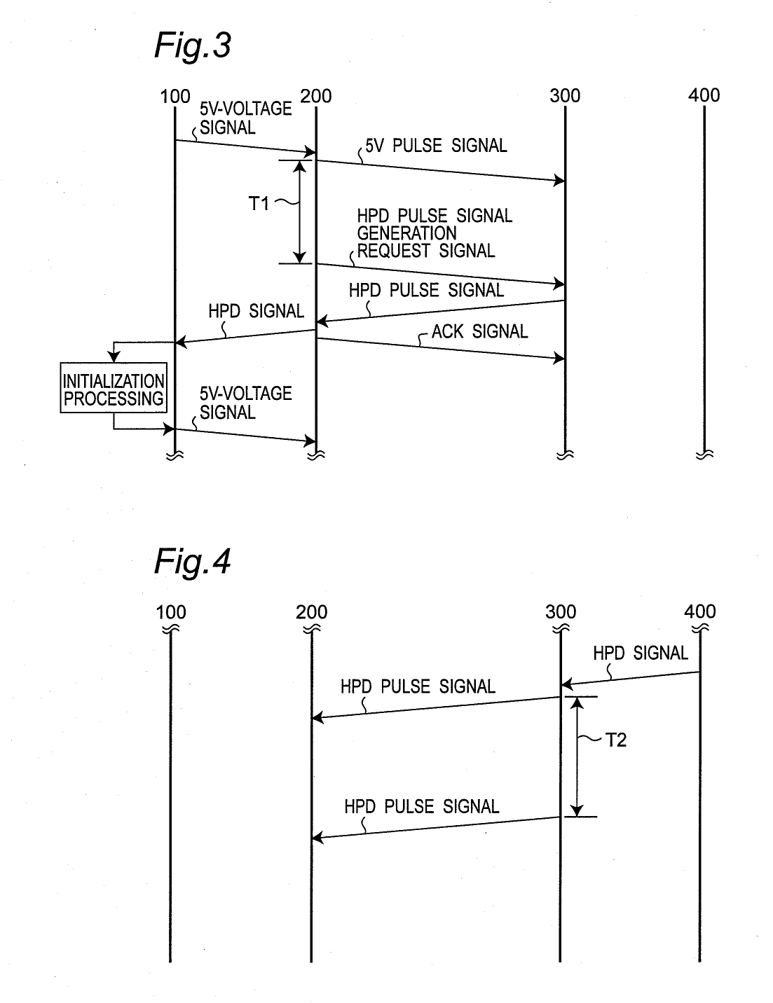

FIG. 3 is a sequence diagram showing a second operation example of the wireless transmission system shown in FIG. 1. Referring to FIG. 3, upon detecting that the adapter apparatus 200 in the power-ON state is connected to the DVD player 100 in the power-ON state, the CPU 111 of the DVD player 100 generates the 5V-voltage signal, and outputs the 5V-voltage signal to the CPU 11 of the adapter apparatus 200 in a manner similar to that of FIG. 2. In response to this, the CPU 11 of the adapter apparatus 200 generates the 5V-pulse signal and wirelessly transmits the 5V-pulse signal to the CPU 51 of the adapter apparatus 300 via the antennas 26 and 56 in a manner similar to that of FIG. 2. After wirelessly transmitting the 5V-pulse signal to the CPU 51 of the adapter apparatus 300, the CPU 11 of the adapter apparatus 200 waits for an ACK signal from the CPU 51 of the adapter apparatus 300 for a predetermined waiting time T1. When the CPU 11 of the adapter apparatus 200 does not receive the ACK signal from the CPU 51 of the adapter apparatus 300 by the end of the waiting, then the CPU 11 of the adapter apparatus 200 judges that a communication failure occurs between the adapter apparatuses 200 and 300, generates an HPD pulse signal generation request signal, and wirelessly transmits the HPD pulse signal generation request signal to the CPU 51 of the adapter apparatus 300. In response to this, the CPU 51 of the adapter apparatus 300 controls the HPD pulse signal generation circuit 73 to generate the HPD pulse signal having a predetermined pulse width, and to output the HPD pulse signal to the CPU 51. Further, the CPU 51 wirelessly transmits the HPD pulse signal from the HPD pulse signal generation circuit 73 to the CPU 11 of the adapter apparatus 200 via the antennas 56 and 26. Upon receiving the HPD pulse signal normally, the CPU 11 of the adapter apparatus 200 generates the HPD signal and outputs the HPD signal to the CPU 111 of the DVD player 100 in a manner similar to that of FIG. 2. Then, the CPU 11 generates the ACK signal indicating that the CPU 11 has received the HPD pulse signal normally, and wirelessly transmits the ACK signal to the CPU 51 of the adapter apparatus 300 via the antennas 26 and 56. Upon receiving the ACK signal, the CPU 51 of the adapter apparatus 300 judges that the HPD pulse signal has been transmitted to the CPU 11 of the adapter apparatus 200 normally. Further, upon receiving the HPD signal, the CPU 111 of the DVD player 100 executes the predetermined initialization processing compliant with the HDMI standard on the HPD signal. After terminating the initialization processing, the CPU 111 of the DVD player 100 generates the 5V-voltage signal again and outputs the 5V-voltage signal to the CPU 11 of the adapter apparatus 200.

Referring to FIG. 3, the CPU 51 of the adapter apparatus 300 may generate the 5V-voltage signal after receiving the 5V-pulse signal, and output the 5V-voltage signal to the CPU 411 of the PDP apparatus 400. Further, in FIG. 3, the waiting time T1 is set to be longer than a time interval required for the CPU 11 of the adapter apparatus 200 to receive the ACK signal indicating that the 5V-pulse signal has been transmitted normally from the CPU 51 of the adapter apparatus 300 after wirelessly transmitting the 5V-pulse signal to the CPU 51 of the adapter apparatus 300.

FIG. 4 is a sequence diagram showing a third operation example of the wireless transmission system shown in FIG. 1. Referring to FIG. 4, the CPU 411 of the PDP apparatus 400 generates the HPD signal and outputs the HPD signal to the CPU 51 of the adapter apparatus 300 in a manner similar to that of FIG. 2. In response to this, the CPU 51 of the adapter apparatus 300 generates the HPD pulse signal and wirelessly transmits the HPD pulse signal to the CPU 11 of the adapter apparatus 200 via the antennas 56 and 26 in a manner similar to that of FIG. 2. After wirelessly transmitting the HPD pulse signal to the CPU 11 of the adapter apparatus 200, the CPU 11 of the adapter apparatus 200 waits for an ACK signal from the CPU 11 of the adapter apparatus 200 for a predetermined waiting time T2. When the CPU 51 of the adapter apparatus 300 does not receive the ACK signal from the CPU 11 of the adapter apparatus 200 by the end of the waiting, then the CPU 51 of the adapter apparatus 300 judges that a communication failure occurs between the adapter apparatuses 200 and 300, generates the HPD pulse signal again, and wirelessly transmits the HPD pulse signal to the CPU 11 of the adapter apparatus 200. Then, the CPU 51 of the adapter apparatus 300 repeatedly waits and retransmits the HPD pulse signal until receiving the ACK signal from the CPU 11 of the adapter apparatus 200. Namely, the waiting and the retransmission of the HPD pulse signal are repeated until the adapter apparatus 200 normally receives the HPD pulse signal, generates the HPD signal based on the received HPD pulse signal, and outputs the HPD signal to the DVD 100, and the DVD player 100 terminates the initialization processing.

Referring to FIG. 4, the waiting time T2 is set to be longer than a time interval required for the CPU 51 of the adapter apparatus 300 to receive the ACK signal indicating that the HPD pulse signal has been transmitted normally from the CPU 11 of the adapter apparatus 200 after wirelessly transmitting the HPD pulse signal to the CPU 11 of the adapter apparatus 200.

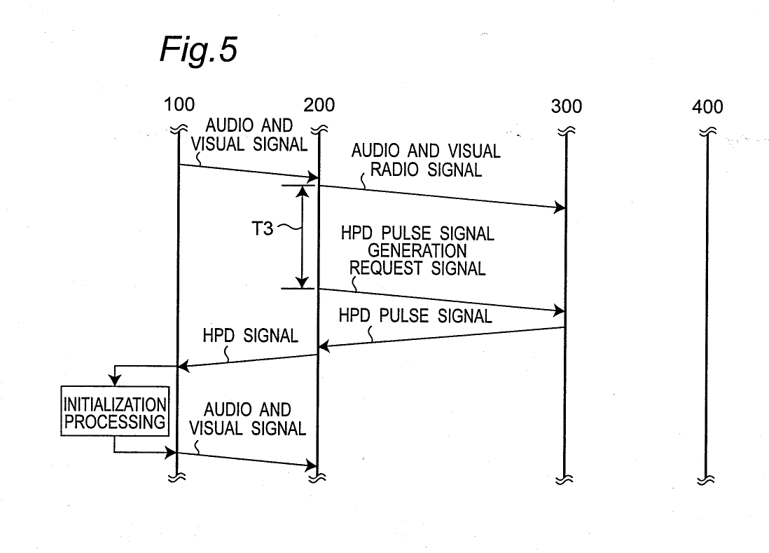

FIG. 5 is a sequence diagram showing a fourth operation example of the wireless transmission system shown in FIG. 1. Referring to FIG. 5, the CPU 111 of the DVD player 100 generates the audio and visual signal and outputs the audio and visual signal to the CPU 11 of the adapter apparatus 200 in a manner similar to that of FIG. 2. In response to this, the CPU 11 of the adapter apparatus 200 wirelessly transmits the inputted audio and visual signal to the CPU 51 of the adapter apparatus 300 via the antennas 26 and 56 as the audio and visual radio signal. After wirelessly transmitting the inputted audio and visual signal to the CPU 51 of the adapter apparatus 300, the CPU 11 of the adapter apparatus 200 waits for an ACK signal from the CPU 51 of the adapter apparatus 300 for a predetermined waiting time T3. When the CPU 11 of the adapter apparatus 200 does not receive the ACK signal from the CPU 51 of the adapter apparatus 300 by the end of the waiting, then the CPU 11 judges that a communication failure occurs between the adapter apparatuses 200 and 300. In addition, the CPU 111 generates the HPD pulse signal generation request signal for requesting generation of the HPD pulse signal, and wirelessly transmits the HPD pulse signal generation request signal to the CPU 51 of the adapter apparatus 300. In response to this, the CPU 51 of the adapter apparatus 300 controls the HPD pulse signal generation circuit 73 to generate the HPD pulse signal having the predetermined pulse width and to output the HPD pulse signal to the CPU 51. Further, the CPU 51 wirelessly transmits the HPD pulse signal from the HPD pulse signal generation circuit 73 to the CPU 11 of the adapter apparatus 200 via the antennas 56 and 26. Upon receiving the HPD pulse signal normally, the CPU 11 of the adapter apparatus 200 generates the HPD signal and outputs the HPD signal to the CPU 111 of the DVD player 100 in a manner similar to that of FIG. 2. Then, the CPU 11 generates the ACK signal indicating that the CPU 11 has received the HPD pulse signal normally, and wirelessly transmits the ACK signal to the CPU 51 of the adapter apparatus 300 via the antennas 26 and 56. Upon receiving the ACK signal, the CPU 51 of the adapter apparatus 300 judges that the HPD pulse signal has been transmitted to the CPU 11 of the adapter apparatus 200 normally. Further, upon receiving the HPD signal, the CPU 111 of the DVD player 100 executes the predetermined initialization processing compliant with the HDMI standard. After terminating the initialization processing, the CPU 111 of the DVD player 100 generates the audio and visual signal again, and outputs the audio and visual signal to the CPU 11 of the adapter apparatus 200.

Referring to FIG. 5, the waiting time T3 is set to be longer than a time interval required for the CPU 11 of the adapter apparatus 200 to receive the ACK signal indicating that the audio and visual radio signal has been transmitted normally from the CPU 51 of the adapter apparatus 300 after wirelessly transmitting the audio and visual radio signal to the CPU 51 of the adapter apparatus 300.

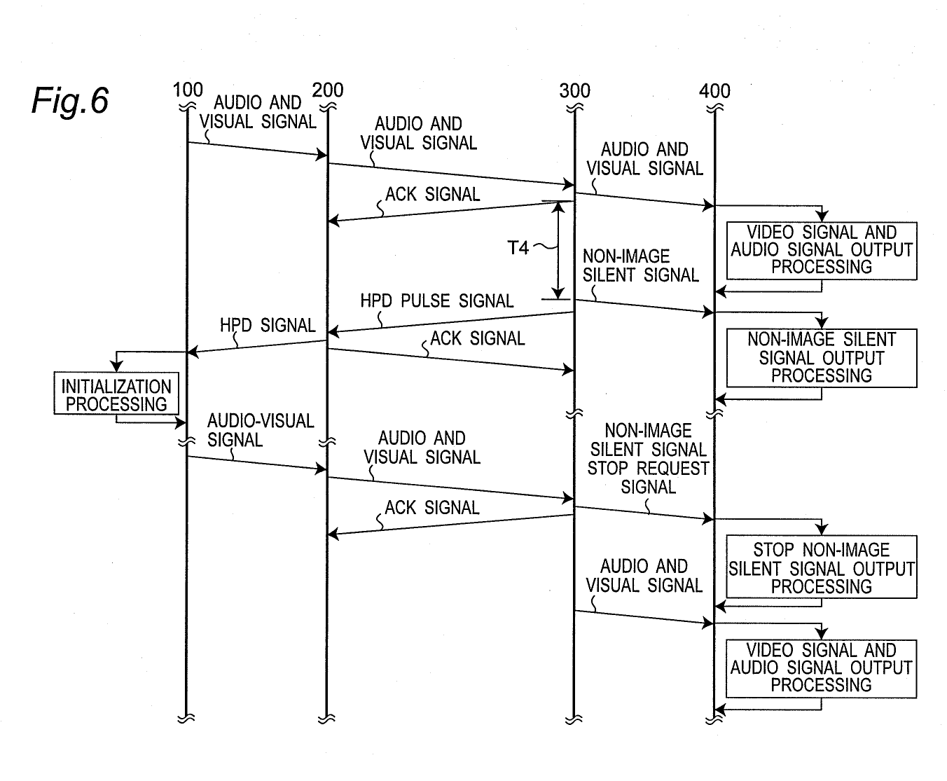

FIG. 6 is a sequence diagram showing a fifth operation example of the wireless transmission system shown in FIG. 1. Referring to FIG. 6, the CPU 111 of the DVD player 100 generates the audio and visual signal and outputs the audio and visual signal to the CPU 11 of the adapter apparatus 200 in a manner similar to that of FIG. 2. In response to this, the CPU 11 of the adapter apparatus 200 wirelessly transmits the inputted audio and visual signal to the CPU 51 of the adapter apparatus 300 via the antennas 26 and 56 as the audio and visual radio signal in a manner similar to that of FIG. 2. In response to this, the CPU 51 of the adapter apparatus 300 executes the decoding processing on the received audio and visual signal based on the predetermined decoding method, calculates the PER of the processed audio and visual signal. Then, the CPU 51 of the adapter apparatus 300 outputs the processed audio and visual signal to the CPU 411 of the PDP apparatus 400 when the PER is equal to or lower than the predetermined value, in a manner similar to that of FIG. 2. Then, the CPU 51 generates the ACK signal indicating that the CPU 51 has received the audio and visual signal normally, and wirelessly transmits the ACK signal to the CPU 11 of the adapter apparatus 200. Upon receiving the ACK signal, the CPU 11 of the adapter apparatus 200 judges that the audio and visual signal has been transmitted to the CPU 51 of the adapter apparatus 300 normally. Further, similarly to FIG. 2, the CPU 411 of the PDP apparatus 400 generates the video signal and the audio signal based on the inputted audio and visual signal, outputs the video signal to the display 72 via the video signal processing circuit 71 to display the video signal on the display 72, and outputs the audio signal to the loudspeaker 454 via the audio signal processing circuit 453.

Referring to FIG. 6, the CPU 51 of the adapter apparatus 300 generates the ACK signal indicating that the CPU 51 has received the audio and visual signal from the CPU 11 of the adapter apparatus 200 normally, wirelessly transmits the ACK signal to the CPU 11 of the adapter apparatus 200, and waits for a next audio and visual signal for a predetermined waiting time T4. When the CPU 51 of the adapter apparatus 300 does not receive the next audio and visual signal normally or does not receive any next audio and visual signal at all from the CPU 11 of the adapter apparatus 200 by the end of the waiting, then the CPU 51 judges that a communication failure occurs between the adapter apparatuses 200 and 300. The CPU 51 of the adapter apparatus 300 controls the non-image silent signal generation circuit 75 to generate the non-image silent signal including the black image signal and the silent signal each having the predetermined specifications and to output the non-image silent signal to the CPU 51, and thereafter, outputs the inputted non-image silent signal to the CPU 411 of the PDP apparatus 400. In response to this, the CPU 411 of the PDP apparatus 400 generates the black image signal and the silent signal based on the inputted non-image silent signal, outputs the black image signal to the display 72 via the video signal processing circuit 71 to display the black image signal on the display 72, and outputs the silent signal to the loudspeaker 454 via the audio signal processing circuit 453.

In addition, in FIG. 6, after outputting the non-image silent signal to the CPU 411 of the PDP apparatus 400, the CPU 51 of the adapter apparatus 300 controls the HPD pulse signal generation circuit 73 to generate the HPD pulse signal having the predetermined pulse width and to output the HPD pulse signal to the CPU 51, and thereafter, wirelessly transmits the inputted HPD pulse signal to the CPU 11 of the adapter apparatus 200 via the antennas 56 and 26. In response to this, the CPU 11 of the adapter apparatus 200 generates the HPD signal based on the received HPD pulse signal and outputs the HPD signal to the CPU 111 of the DVD player 100 when the CPU 11 has received the HPD pulse signal normally. Then, the CPU 11 generates the ACK signal indicating that the CPU 11 has received the HPD pulse signal normally, and wirelessly transmits the ACK signal to the CPU 51 of the adapter apparatus 300 via the antennas 26 and 56. Upon receiving the ACK signal, the CPU 51 of the adapter apparatus 300 judges that the HPD pulse signal has been transmitted to the CPU 11 of the adapter apparatus 200 normally. Further, upon receiving the HPD signal, the CPU 111 of the DVD player 100 executes the predetermined initialization processing compliant with the HDMI standard in a manner similar to that of FIG. 2.

In addition, in FIG. 6, after terminating the initialization processing, the CPU 111 of the DVD player 100 generates the audio and visual signal and outputs the audio and visual signal to the CPU 11 of the adapter apparatus 200 in a manner similar to that of FIG. 2. In response to this, the CPU 11 of the adapter apparatus 200 wirelessly transmits the inputted audio and visual signal to the CPU 51 of the adapter apparatus 300 via the antennas 26 and 56 as the audio and visual radio signal. In response to this, the CPU 51 of the adapter apparatus 300 executes the decoding processing on the received audio and visual signal based on the predetermined decoding method, calculates the PER of the processed audio and visual signal in a manner similar to that of FIG. 2. Further, the CPU 51 judges that the CPU 51 has received the audio and visual signal normally when the PER is equal to or lower than the predetermined value. In this case, the CPU 51 controls the non-image silent signal generation circuit 75 to stop generating the non-image silent signal, and generates a non-image silent signal generation stop request signal, and outputs the non-image silent signal generation stop request signal to the CPU 411 of the PDP apparatus 400. In response to this, the CPU 411 of the PDP apparatus 400 stops generating the black image signal and the silent signal, and stops outputting the black image signal and the silent signal to the display 452 and the loudspeaker 454, respectively. Further, the CPU 51 of the adapter apparatus 300 generates the ACK signal indicating that the CPU 51 has received the audio and visual signal normally, and outputs the processed audio and visual signal to the CPU 411 of the PDP apparatus 400. Upon receiving the ACK signal, the CPU 11 of the adapter apparatus 200 judges that the audio and visual signal has been transmitted normally to the CPU 51 of the adapter apparatus 300. Further, the CPU 411 of the PDP apparatus 400 generates the video signal and the audio signal based on the inputted audio and visual signal, outputs the video signal to the display 72 via the video signal processing circuit 71 to display the video signal on the display 72, and outputs the audio signal to the loudspeaker 45 via the audio signal processing circuit 453.

Referring to FIG. 6, the waiting time T4 is set to be longer than a time interval generally required for the CPU 51 of the adapter apparatus 300 to receive a next audio and visual radio signal after receiving an audio and visual radio signal normally.

As described so far in detail, while the adapter apparatus 200 according to the present preferred embodiment can wirelessly transmit the radio signals including the 5V-voltage signal and the audio and visual signal generated by the CPU 111 of the DVD player 100, respectively, to the adapter apparatus 300, the adapter apparatus 200 can receive the radio signal including the HPD signal from the adapter apparatus 300. Further, while the adapter apparatus 300 according to the present preferred embodiment can receive the radio signals including the 5V-voltage signal and the audio and visual signal, respectively, from the adapter apparatus 200, the adapter apparatus 300 can wirelessly transmit the radio signal including the HPD signal to the adapter apparatus 200. Accordingly, the 5V-voltage signal and the audio and visual signal generated by the CPU 111 of the DVD player 100 can be wirelessly transmitted to the PDP apparatus 400 via the adapter apparatuses 200 and 300, and the HPD signal generated by the CPU 411 of the PDP apparatus 400 can be wirelessly transmitted to the DVD player 100 via the adapter apparatuses 300 and 200. Namely, by connecting the DVD player 100 and the PDP apparatus 400 to each other via a wireless transmission path, the connection can be realized without using any HDMI cable and simplified as compared with the prior arts. This leads to enhanced flexibility of the installation locations of the DVD player 100 connected to the adapter apparatus 200 and the PDP apparatus 400 connected to the adapter apparatus 300.

In addition, in the wireless transmission system according to the present preferred embodiment, upon detecting the communication failure between the adapter apparatuses 200 and 300, the CPU 11 generates the HPD pulse signal generation request signal and wirelessly transmits the same signal to the CPU 51 of the adapter apparatus 300. Then, the CPU 11 receives the HPD pulse signal from the adapter apparatus 300, generates the HPD signal based on the received HPD pulse signal, and outputs the HPD signal to the DVD player 100. On the other hand, upon detecting the communication failure between the adapter apparatuses 200 and 300, the CPU 51 generates the HPD pulse signal and wirelessly transmits the HPD pulse signal to the adapter apparatus 200, so as to control the adapter apparatus 200 to generate the HPD signal and to output the HPD signal to the DVD player 100. Accordingly, when the communication failure occurs between the adapter apparatuses 200 and 300, the DVD player 100 receives the HPD signal from the adapter apparatus 200 and executes the predetermined initialization processing in response to the HPD signal. Accordingly, it is possible to ensure that the audio and visual signal, the 5V-voltage signal, and the HPD signal are transmitted between the DVD player 100 and the PDP apparatus 400 via the adapter apparatuses 200 and 300.

In addition, according to the HDMI standard and the DVI standard, the signal sink apparatus is required to generate the HPD signal and output the same signal to the signal source apparatus, after receiving the 5V-voltage signal. In the wireless transmission system according to the present preferred embodiment, the CPU 51 of the adapter apparatus 300 generates the 5V-voltage signal and outputs the 5V-voltage signal to the CPU 411 of the PDP apparatus 400. Then, the CPU 51 of the adapter apparatus 300 generates the HPD pulse signal based on the HPD signal from the CPU 411 of the PDP apparatus 400, and wirelessly transmits the HPD pulse signal to the CPU 11 of the adapter apparatus 200. Accordingly, the processing executed by the CPU 11 of the adapter apparatus 200 for generating the HPD signal and outputting the HPD signal to the CPU 111 of the DVD player 100 is executed after the processing executed by the CPU 51 of the adapter apparatus 300 for generating the 5V-voltage signal and outputting the 5V-voltage signal to the CPU 411 of the PDP apparatus 400. Therefore, the 5V-voltage signal and the HPD signal can be transmitted according to transmission procedures compliant with the HDMI standard and the DVI standard.

In the above-stated preferred embodiment, after wirelessly transmitting the 5V-pulse signal to the CPU 51 of the adapter apparatus 300, the CPU 11 of the adapter apparatus 200 waits for the ACK signal from the CPU 51 of the adapter apparatus 300 for the predetermined waiting time T1. When the CPU 11 of the adapter apparatus 200 does not receive the ACK signal from the CPU 51 of the adapter apparatus 300 by the end of the waiting, then the CPU 11 judges that the communication failure occurs between the adapter apparatuses 200 and 300. In addition, after wirelessly transmitting the audio and visual signal to the CPU 51 of the adapter apparatus 300, the CPU 11 of the adapter apparatus 200 waits for the ACK signal from the CPU 51 of the adapter apparatus 300 for the predetermined waiting time T3. When the CPU 11 of the adapter apparatus 200 does not receive the ACK signal from the CPU 51 of the adapter apparatus 300 by the end of the waiting, then the CPU 11 judges that the communication failure occurs between the adapter apparatuses 200 and 300. Further, after wirelessly transmitting the HPD pulse signal to the CPU 11 of the adapter apparatus 200, the CPU 51 of the adapter apparatus 300 waits for the ACK signal from the CPU 11 of the adapter apparatus 200 for the predetermined waiting time T2. When the CPU 51 does not receive the ACK signal from the CPU 11 of the adapter apparatus 200 by the end of the waiting, then the CPU 51 judges that the communication failure occurs between the adapter apparatuses 200 and 300. However, the present invention is not limited to this. When there is detected a packet loss equal to or greater than a predetermined threshold value, or when a retransmission request is received a predetermined number of times or more from the counterpart apparatus, it may be judged that the communication failure occurs between the adapter apparatuses 200 and 300, and the adapter apparatus 300 may be controlled to generate the HPD pulse signal and to wirelessly transmit the HPD pulse signal to the adapter apparatus 200.

In addition, in the above-stated preferred embodiment, the CPU 51 of the adapter apparatus 300 judges whether or not the CPU 51 has received the audio and visual signal normally based on the PER related to the received audio and visual signal. However, the present invention is not limited to this. The CPU 51 of the adapter apparatus 300 may judge whether or not the CPU 51 has received the audio and visual signal normally based on a packet loss rate related to the received audio and visual signal. Alternatively, after having received the audio and visual radio signal, the 5V-voltage signal or the other radio signal normally, when the CPU 51 of the adapter apparatus 300 does not receive normally or does not at all receive the audio and visual radio signal, the 5V-voltage signal or the other radio signal, then the CPU 51 may judge that the communication failure occurs between the adapter apparatuses 200 and 300. In this case, the CPU 51 may generate the HPD pulse signal, wirelessly transmit the HPD pulse signal to the adapter apparatus 200, as well as controlling the non-image silent signal generation circuit 75 to generate the non-image silent signal and to output the non-image silent signal to the CPU 51, and outputting the inputted non-image silent signal to the CPU 411 of the PDP apparatus 400.

Further, in the above-stated preferred embodiment, upon detecting the communication failure between the adapter apparatuses 200 and 300, the adapter apparatus 300 generates the non-image silent signal and outputs the non-image silent signal to the PDP apparatus 400. However, the present invention is not limited to this. The adapter apparatus 300 may be configured to generate the black image signal, to output the black image signal to the PDP apparatus 400, and not to output the audio signal to the PDP apparatus 400.

In the above-stated preferred embodiment, after receiving the 5V-pulse signal, the CPU 51 of the adapter apparatus 300 controls the 5V-voltage signal generation circuit 72 to generate the 5V-voltage signal based on the received 5V-pulse signal and to output the 5V-voltage signal to the CPU 51, and thereafter, the CPU 51 outputs the 5V-voltage signal inputted from the 5V-voltage signal generation circuit 72 to the CPU 411 of the PDP apparatus 400. However, the present invention is not limited to this. Upon detecting that the adapter apparatus 300 has been connected to the PDP apparatus 400 in the power-ON state, the CPU 51 of the adapter apparatus 300 may control the 5V-voltage signal generation circuit 72 or further means to generate the 5V-voltage signal and to output the 5V-voltage signal to the CPU 51, and may output the 5V-voltage signal from the 5V-voltage signal generation circuit 72 or the further means to the CPU 411 of the PDP apparatus 400.

In addition, in the above-stated preferred embodiment, upon receiving the HPD pulse signal normally, the CPU 11 of the adapter apparatus 200 generates the ACK signal and wirelessly transmits the ACK signal to the CPU 51 of the adapter apparatus 300. However, the present invention is not limited to this and the wireless transmission system may be configured as follows. According to the HDMI standard and the DVI standard, upon receiving the HPD signal normally, the signal source apparatus generates 64-bit data and outputs the 64-bit data to the signal sink apparatus. Accordingly, the CPU 111 of the DVD player 100 that has received the HPD signal normally may generate the 64-bit data and output the same data to the CPU 11 of the adapter apparatus 200. The CPU 11 of the adapter apparatus 200 may wirelessly transmit the inputted 64-bit data to the CPU 51 of the adapter apparatus 300. Upon receiving the 64-bit data, the CPU 51 of the adapter apparatus 300 may judge that the HPD pulse signal has been transmitted normally.

In the above-stated preferred embodiment, the 5V-pulse signal generation circuit 22 generates the 5V-pulse signal based on the 5V-voltage signal. However, the present invention is not limited to this. The 5V-pulse signal generation circuit 22 may generate a 5V-flag signal. In addition, in the above-stated preferred embodiment, the HPD pulse signal generation circuit 73 generates the HPD pulse signal based on the HPD signal. However, the present invention is not limited to this. The HPD pulse signal generation circuit 73 may generate an HPD flag signal. Further, in the above-stated preferred embodiment, the 5V-pulse signal having the high level and the HPD pulse signal having the high level are active signals. However, the present invention is not limited to this. A 5V-pulse signal having the low level and an HPD pulse signal having the low level may be the active signals. Still further, in the above-stated preferred embodiment, upon detecting that the voltage level of the HPD signal line of the HDMI cable 502 has the low level over the time interval equal to or more than 100 milliseconds, the CPU 51 controls the HPD pulse signal generation circuit 73 to generate the HPD pulse signal and to output the HPD pulse signal to the CPU 51. However, the present invention is not limited to this. Upon detecting that the voltage level of the HPD signal line of the HDMI cable 502 is changed to the low level, the CPU 51 may control the HPD pulse signal generation circuit 73 to generate the HPD pulse signal and to output the HPD pulse signal to the CPU 51. Then, upon detecting that the voltage level of the HPD signal line of the HDMI cable 502 has the low level over a time interval equal to or more than 100 milliseconds, the CPU 51 may wirelessly transmit the HPD pulse signal to the adapter apparatus 200.

In addition, in the above-stated preferred embodiment, the adapter apparatus 200 wirelessly transmits the HPD pulse signal generation request signal to the adapter apparatus 300. However, the present invention is not limited to this. The adapter apparatus 200 may transmit the HPD pulse signal generation request signal to the adapter apparatus 300 by wired transmission.

Further, in FIGS. 2 to 6, upon receiving the HPD pulse signal, the CPU 11 of the adapter apparatus 200 may execute an initialization processing on the adapter apparatus 200. Further, in FIG. 2, after receiving the 5V-pulse signal normally, the CPU 51 of the adapter apparatus 300 may generate the ACK signal and wirelessly transmit the ACK signal to the CPU 11 of the adapter apparatus 200, and thereafter, the CPU 51 of the adapter apparatus 300 may generate the 5V-voltage signal and output the 5V-voltage signal to the CPU 411 of the PDP apparatus 400. Alternatively, after receiving the 5V-pulse signal normally, the CPU 51 of the adapter apparatus 300 may generate the 5V-voltage signal and output the 5V-voltage signal to the CPU 411 of the PDP apparatus 400 simultaneously with generating the ACK signal and wirelessly transmitting the ACK signal to the CPU 11 of the adapter apparatus 200. Further, in FIGS. 2 to 6, after receiving the audio and visual signal normally, the CPU 51 of the adapter apparatus 300 may generate the ACK signal and wirelessly transmit the ACK signal to the CPU 11 of the adapter apparatus 200, and thereafter, the CPU 51 of the adapter apparatus 300 may output the processed audio and visual signal to the CPU 411 of the PDP apparatus 400. Alternatively, after receiving the audio and visual signal normally, the CPU 51 of the adapter apparatus 300 may output the processed audio and visual signal to the CPU 411 of the PDP apparatus 400 simultaneously with generating the ACK signal and wirelessly transmitting the ACK signal to the CPU 11 of the adapter apparatus 200. Further, in FIGS. 2, 3, 5, and 6, after receiving the HPD pulse signal normally, the CPU 11 of the adapter apparatus 200 may generate the ACK signal and wirelessly transmit the ACK signal to the CPU 51 of the adapter apparatus 300, and thereafter, the CPU 11 of the adapter apparatus 200 may generate the HPD signal and output the HPD signal to the CPU 111 of the DVD player 100. Alternatively, after receiving the HPD pulse signal normally, the CPU 11 of the adapter apparatus 200 may generate the HPD signal and output the HPD signal to the CPU 111 of the DVD player 100 simultaneously with generating the ACK signal and wirelessly transmitting the ACK signal to the CPU 51 of the adapter apparatus 300.

### Second Preferred Embodiment

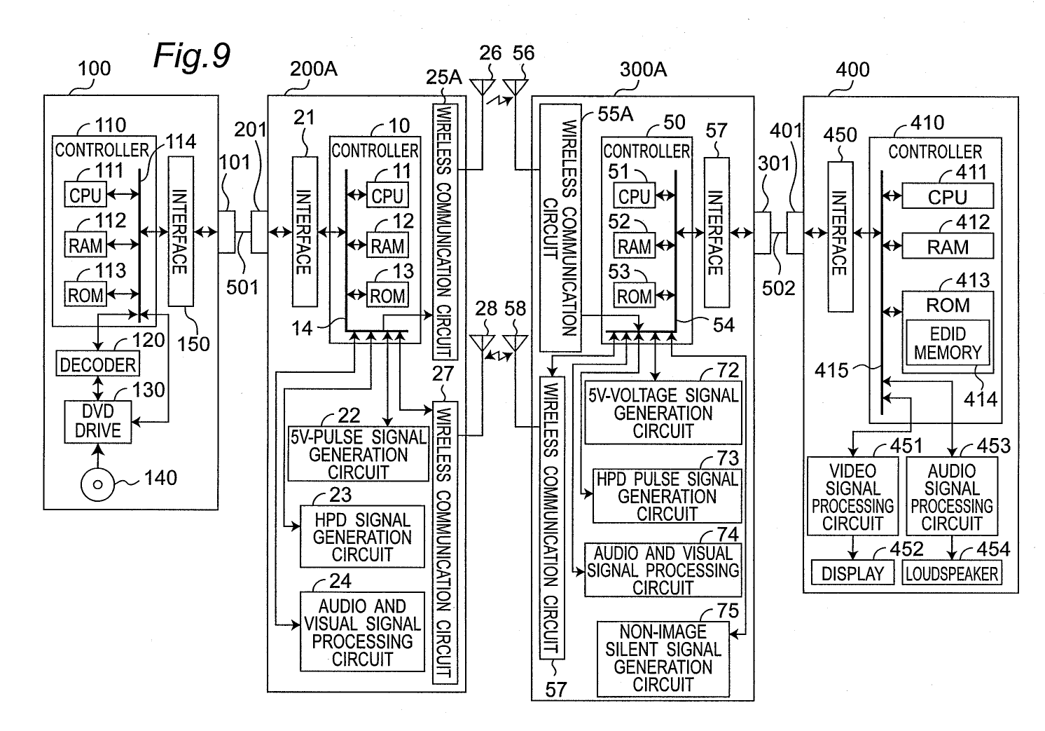

FIG. 9 is a block diagram showing a configuration of a wireless transmission system according to a second preferred embodiment of the present invention, including the DVD player 100, adapter apparatuses 200A and 300A, and the PDP apparatus 400. As compared with the wireless transmission system according to the first preferred embodiment, the wireless transmission system according to the second preferred embodiment is characterized by including the adapter apparatuses 200A and 300A in place of the adapter apparatuses 200 and 300. Further, as compared with the adapter apparatus 200, the adapter apparatus 200A is characterized by including a wireless communication circuit 25A in place of the wireless communication circuit 25, and further including a wireless communication circuit 27 and an antenna 28. As compared with the adapter apparatus 300, the adapter apparatus 300A is characterized by including a wireless communication circuit 55A in place of the wireless communication circuit 55, and further including a wireless communication circuit 57 and an antenna 58. As compared with the wireless transmission system according to the first preferred embodiment, the wireless transmission system according to the second preferred embodiment is characterized in that a frequency of a radio channel for transmitting the video signal between the adapter apparatuses 200A and 300A is different from a frequency of a radio channel for transmitting the audio signal, the 5V-pulse signal, the HPD pulse signal, an ACK signal, and the HPD pulse generation request signal. Differences between the first preferred embodiment and the second preferred embodiment will now be described in detail.

In the adapter apparatus 200A, the CPU 11 outputs the video signal included in the audio and visual signal inputted from the audio and visual signal processing circuit 24 to the wireless communication circuit 25A, while the CPU 11 outputs the audio signal included in the audio and visual signal inputted from the audio and visual signal processing circuit 24, the 5V-pulse signal inputted from the 5V-pulse signal generation circuit 22, the ACK signal, and the HPD pulse generation request signal, to the wireless communication circuit 27.

In addition, in the adapter apparatus 200A, the wireless communication circuit 25A digitally modulates a radio carrier wave into a radio video signal using a predetermined digital modulation method according to an inputted video signal, executes a high-frequency signal processing such as high frequency conversion and high frequency amplification on the radio video signal, and wirelessly transmits the processed radio video signal to the adapter apparatus 300A via the antenna 26. Further, the wireless communication circuit 27 digitally modulates a radio carrier wave into radio signals using a predetermined digital modulation method according to the inputted audio signal, the 5V-pulse signal, the ACK signal, and the HDP pulse signal generation request signal, executes a high frequency signal processing such as high frequency conversion on the radio signals, and wirelessly transmits the processed radio signals to the adapter apparatus 300A via the antenna 26 using a first radio channel. Further, the wireless communication circuit 27 executes a high frequency signal processing such as low frequency conversion and high frequency amplification on a radio signal received via the antenna 28, demodulates the processed radio signal to a baseband signal using a predetermined digital demodulation method, converts the baseband signal into the HDP pulse signal or the ACK signal, and outputs the HDP pulse signal or the ACK signal to the CPU 11.

In the adapter apparatus 300A, the wireless communication circuit 55A executes a high-frequency signal processing such as low frequency conversion and high frequency amplification on the radio video signal received via the antenna 56, demodulates the processed radio video signal to a baseband signal using a predetermined digital demodulation method, converts the baseband signal into the video signal, and outputs the video signal to the CPU 51.

Further, in the adapter apparatus 300A, the CPU 51 outputs the HPD pulse signal from the HPD pulse signal generation circuit 73 and an ACK signal to the wireless communication circuit 57. The wireless communication circuit 57 digitally modulates a radio carrier wave into radio signals using a predetermined digital modulation method according to the inputted HPD pulse signal and ACK signal, executes a high frequency signal processing such as high frequency conversion and high frequency amplification on the radio signals, and wirelessly transmits the processed radio signals to the adapter apparatus 200A via the antenna 58 using a second radio channel whose frequency is different from that of the first radio channel. Further, the wireless communication circuit 57 executes a high frequency signal processing such as low frequency conversion and high frequency amplification on the radio signal received via the antenna 58, demodulates the processed radio signal to a baseband signal using a predetermined digital demodulation method, converts the baseband signal into the audio signal, the 5V-pulse signal, the ACK signal or the HPD pulse generation request signal, and outputs the same signals to the CPU 51.

The wireless transmission system according to the second preferred embodiment exhibits the advantages similar to those of the wireless transmission system according to the first preferred embodiment. In addition, the radio video signal is wirelessly transmitted via the antennas 26 and 56 using the first radio channel, while the radio signals including the audio signal, the 5V-pulse signal, the HPD pulse signal, the ACK signal, and the HPD pulse generation request signal, respectively, are wirelessly transmitted via the antennas 28 and 58 using the second radio channel. Accordingly, as compared with the wireless transmission system according to the first preferred embodiment, the wireless transmission system according to the present preferred embodiment can wirelessly transmit the radio video signal via the antennas 26 and 56, using a transmission path having a larger transmission capacity.

In the above-stated preferred embodiment, the CPU 11 of the adapter apparatus 200A wirelessly transmits the video signal to the adapter apparatus 300A via the antennas 26 and 56, and transmits the audio signal to the adapter apparatus 300A via the antennas 28 and 58. However, the present invention is not limited to this. The audio and visual signal may be wirelessly transmitted to the adapter apparatus 300A via the antennas 26 and 56. Further, when the wireless communication via the antennas 26 and 56 is held normally between the adapter apparatuses 200A and 300A, the CPU 51 of the adapter apparatus 200A may judge that the wireless communication via the antennas 28 and 58 is held normally and not wirelessly transmit the ACK signal to the CPU 11 of the adapter apparatus 200A via the antenna 56 or 58.

### Third Preferred Embodiment

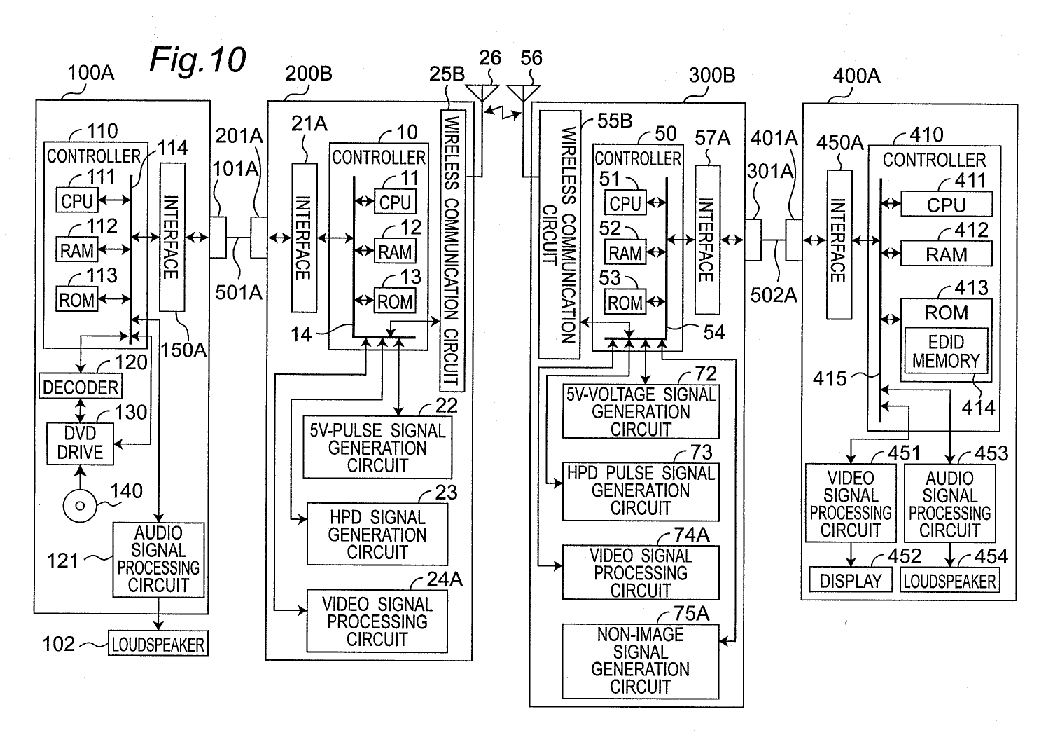

FIG. 10 is a block diagram showing a configuration of a wireless transmission system according to a third preferred embodiment of the present invention, including a DVD player 100A, adapter apparatuses 200B and 300B, and a PDP apparatus 400A. The wireless transmission system shown in FIG. 10 is provided for wirelessly transmitting the video signal and the 5V-voltage signal from the DVD player 100A to the PDP apparatus 400A via the adapter apparatuses 200B and 300B, and for wirelessly transmitting the HPD signal from the PDP apparatus 400A to the DVD player 100A via the adapter apparatuses 300B and 200B. In this case, as compared with the wireless transmission system according to the first preferred embodiment, the wireless transmission system according to the third preferred embodiment is characterized by including the DVD player 100A of a DVI source apparatus which is a signal source apparatus for transmitting and receiving signals compliant with the DVI standard, and a DVI sink source apparatus of a signal sink apparatus for transmitting and receiving signals compliant with the DVI standard. Differences between the third preferred embodiment and the first preferred embodiment will now be described in detail.

The DVD player 100A is a well-known DVI source apparatus, and connected to the adapter apparatus 200B via a DVI terminal 101A and a DVI cable 501A of the DVD player 100A and a DVI terminal 201A of the adapter apparatus 200B. The PDP apparatus 400A is a well-known DVI sink apparatus, and connected to the adapter apparatus 300B via a DVI terminal 401A and a DVI cable 502A of the PDP apparatus 400A and a DVI terminal 301A of the adapter apparatus 300B. Further, the adapter apparatuses 200B and 300B are wirelessly connected to each other via an antenna 26 of the adapter apparatus 200B and an antenna 56 of the adapter apparatus 300B.

The DVI terminals 101A, 201A, 301A, and 401A are data terminals compliant with the DVI standard. The DVI cables 501A and 502A are digital data transmission buses compliant with the DVI standard. Each of the DVI cables 501A and 502A includes a plurality of signal lines for transmitting the video signal, the 5V-voltage signal line for transmitting the 5V-voltage signal, and the HPD signal line for transmitting the HPD signal.

Referring to FIG. 10, as compared with the DVD player 100 shown in FIG. 1, the DVD player 100A is configured by including an interface 150A in place of the interface 150 and the DVI terminal 101A in place of the HDMI terminal 101, and further including an audio signal processing circuit 121 and a loudspeaker 102.

In the DVD player 100A, the interface 150A executes an interface processing for interfacing with the adapter apparatus 200B on an inputted signal, generates a signal and data compliant with the DVI standard, and outputs the signal and the data to the adapter apparatus 200B via the DVI connector 101A, the DVI cable 501A and the DVI connector 201A. In addition, the interface 150A receives a signal inputted from the adapter apparatus 200B via the DVI connector 201A, the DVI cable 501A, and the DVI connector 101A, executes a predetermined interface processing including signal conversion and protocol conversion on the received signal, and outputs the processed signal and data to the CPU 111. Further, the audio signal processing circuit 121 converts an inputted digital audio signal into an analog audio signal, amplifies the analog audio signal, and outputs the amplified analog audio signal to the loudspeaker 102. Further, in the DVD player 100, the CPU 111 outputs the video signal included in the audio and visual signal from the decoder 120 to the adapter apparatus 200B, while executing a predetermined delay processing on the audio signal to synchronize the audio signal with the video signal outputted from the display 452 of the PDP apparatus 400A, and outputs the processed audio signal to the loudspeaker 102 via the audio signal processing circuit 121.

Referring to FIG. 10, as compared with the adapter apparatus 200B shown in FIG. 1, the adapter apparatus 200B is configured by including the DVI terminal 201A, an interface 21A, a video signal processing circuit 24A, and a wireless communication circuit 25B in place of the HDMI terminal 201, the interface 21, the audio and visual signal processing circuit 24, and the wireless communication circuit 25, respectively.

In the adapter apparatus 200B, the interface 21A executes an interface processing for interfacing with the DVD player 100A, and outputs a signal and data compliant with the DVI standard to the DVD player 100A via the DVI connector 201A, the DVI cable 501A, and the DVI connector 101A. In addition, the interface 21A receives a signal inputted from the DVD player 100A via the DVI connector 101A, the DVI cable 501A, and the DVI connector 201A, executes a predetermined interface processing including signal conversion and protocol conversion on the signal, and outputs the processed signal to the CPU 11. In addition, in the adapter apparatus 200B, the video signal processing circuit 24A executes a compression-coding processing based on a predetermined compression-coding method on an inputted video signal, and outputs the processed video signal to the CPU 11.

Further, in the adapter apparatus 200B, the wireless communication circuit 25B digitally modulates a radio carrier wave into a radio video signal using a predetermined digital modulation method according to the inputted video signal, executes a high-frequency signal processing such as high frequency conversion and high frequency amplification on the radio video signal, and wirelessly transmits the processed radio video signal to the adapter apparatus 300B via the antenna 26. Further, the wireless communication circuit 25B digitally modulates a radio carrier wave into radio signals using a predetermined digital modulation method according to an inputted 5V-pulse signal, an ACK signal, and an HDP pulse signal generation request signal, executes a high frequency signal processing such as high frequency conversion on the radio signals, and transmits the processed radio signals to the adapter apparatus 300B via the antenna 26. In addition, the wireless communication circuit 25B executes a high frequency signal processing such as low frequency conversion and high frequency amplification on a radio signal received via the antenna 26, demodulates the processed radio signal to a baseband signal using a predetermined digital demodulation method, converts the baseband signal into the HDP pulse signal or the ACK signal, and outputs the HDP pulse signal or the ACK signal to the CPU 11. In this way, the wireless communication circuit 25B wirelessly transmits the inputted video signal, the 5V-pulse signal, the ACK signal, and the HPD pulse signal generation request signal to the adapter apparatus 300B, while wirelessly receiving the HPD pulse signal and the ACK signal from the adapter apparatus 300B.

Referring to FIG. 10, as compared with the adapter apparatus 300 shown in FIG. 1, the adapter apparatus 300B is configured by including the DVI terminal 301A, an interface 57A, a video signal processing circuit 74A, a non-image signal generation circuit 75A, and a wireless communication circuit 55B in place of the HDMI terminal 301, the interface 57, the audio and visual signal processing circuit 74, the non-image silent signal generation circuit 75, and the wireless communication circuit 55, respectively.

In the adapter apparatus 300B, the video signal processing circuit 74A executes a decoding processing on the inputted video signal according a predetermined decoding method, and outputs the processed video signal to the CPU 51. The non-image signal generation circuit 75A generates the non-image signal including the black image signal having predetermined specifications, and outputs the non-image signal to the CPU 51.

In addition, in the adapter apparatus 300B, the interface 57A executes an interface processing for interfacing with the PDP apparatus 400A, and outputs a signal and data compliant with the DVI standard to the PDP apparatus 400A via the DVI connector 301A, the DVI cable 502A, and the DVI connector 401A. Further, the interface 57A receives a signal inputted from the PDP apparatus 400A via the DVI connector 401A, the DVI cable 502A, and the DVI connector 301A, executes a predetermined interface processing including signal conversion and protocol conversion on the signal, and outputs the processed signal to the CPU 51.

Further, in the adapter apparatus 300B, the wireless communication circuit 55B digitally modulates a radio carrier wave into a radio signal using a predetermined digital modulation method according to an inputted HDP pulse signal and an inputted ACK signal, executes a high-frequency signal processing such as high frequency conversion and high frequency amplification on the radio signal, and transmits the processed radio signal to the adapter apparatus 200B via the antenna 56. Further, the wireless communication circuit 55B executes a high frequency signal processing such as low frequency conversion and high frequency amplification on the radio video signal received via the antenna 56, demodulates the processed radio video signal to a baseband signal using a predetermined digital demodulation method, converts the baseband signal into the video signal, and outputs the video signal to the CPU 51. Further, the wireless communication circuit 55B executes a high frequency signal processing such as low frequency conversion and high frequency amplification on the radio signal received via the antenna 56, demodulates the processed radio signal to a baseband signal using a predetermined digital demodulation method, converts the baseband signal into the 5V-voltage signal, the HPD pulse signal generation request signal or the ACK signal, and outputs the same signals to the CPU 51. In this way, the wireless communication circuit 55B wirelessly transmits the inputted HPD pulse signal and ACK signal to the adapter apparatus 200B, and wirelessly receives the video signal, the 5V-pulse signal, the ACK signal, and the HPD pulse signal generation request signal from the adapter apparatus 200B.

Referring to FIG. 10, as compared with the PDP apparatus 400 shown in FIG. 1, the PDP apparatus 400A is configured by including the DVI terminal 401A and an interface 450A in place of the HDMI terminal 401 and the interface 450. The interface 450A executes an interface processing for interfacing with the adapter apparatus 300B, and outputs a signal and data compliant with the DVI standard to the adapter apparatus 300B via the DVI connector 401A, the DVI cable 502A, and the DVI connector 301A. Further, the interface 450A receives a signal inputted from the adapter apparatus 300B via the DVI connector 301A, the DVI cable 502A, and the DVI connector 501A, executes a predetermined interface processing including signal conversion and protocol conversion on the signal, and outputs the processed signal to the CPU 411.

The wireless transmission system according to the above-stated preferred embodiment exhibits the advantages similar to those of the wireless transmission system according to the first preferred embodiment. Further, as described so far in detail, the adapter apparatus 200B according to the present preferred embodiment can wirelessly transmit the radio signals including the 5V-voltage signal and the video signal generated by the CPU 111 of the DVD player 100A, respectively, to the adapter apparatus 300B, while receiving the radio signal including the HPD signal from the adapter apparatus 300B. Further, the adapter apparatus 300B according to the present preferred embodiment can receive the radio signals including the 5V-voltage signal and the video signal, respectively, from the adapter apparatus 200B, while wirelessly transmitting the radio signal including the HPD signal to the adapter apparatus 200B. Accordingly, the 5V-voltage signal and the video signal generated by the CPU 111 of the DVD player 100A can be wirelessly transmitted to the PDP apparatus 400A via the adapter apparatuses 200B and 300B, and the HPD signal generated by the CPU 411 of the PDP apparatus 400A can be wirelessly transmitted to the DVD player 100A via the adapter apparatuses 300B and 200B. Namely, by connecting the DVD player 100A and the PDP apparatus 400A to each other via a wireless transmission path, the connection can be realized without using any DVI cable and simplified as compared with the prior arts. This leads to enhanced flexibility of the installation locations of the DVD player 100A connected to the adapter apparatus 200B and the PDP apparatus 400A connected to the adapter apparatus 300B.

### Fourth Preferred Embodiment

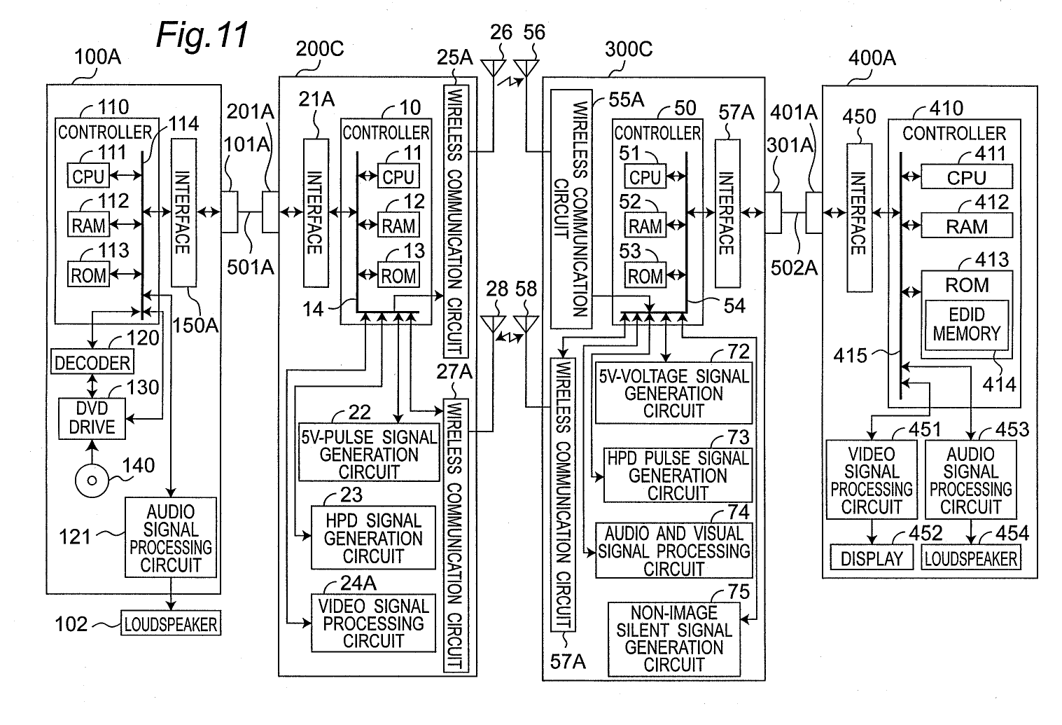

FIG. 11 is a block diagram showing a configuration of a wireless transmission system according to a fourth preferred embodiment of the present invention, including the DVD player 100A, adapter apparatuses 200C and 300C, and the PDP apparatus 400A. As compared with the wireless transmission system according to the third preferred embodiment, the wireless transmission system according to the fourth preferred embodiment is characterized by including adapter apparatuses 200C and 300C in place of the adapter apparatuses 200B and 300B. As compared with the adapter apparatus 200B, the adapter apparatus 200C is characterized by including the wireless communication circuit 25A according to the second preferred embodiment shown in FIG. 9 in place of the wireless communication circuit 25B, and further including a wireless communication circuit 27A and the antenna 28. As compared with the adapter apparatus 300, the adapter apparatus 300A is characterized by including the wireless communication circuit 55A according to the second preferred embodiment shown in FIG. 9 in place of the wireless communication circuit 55B, and further including a wireless communication circuit 57A and the antenna 58. As compared with the wireless transmission system according to the third preferred embodiment, the wireless transmission system according to the fourth preferred embodiment is characterized in that a frequency of a radio channel for transmitting the video signal between the adapter apparatuses 200C and 300C is different from a frequency of a radio channel for transmitting the 5V-pulse signal, the HPD pulse signal, the ACK signal, and the HPD pulse generation request signal. Differences between the fourth preferred embodiment, and the second and third preferred embodiments will now be described in detail.

In the adapter apparatus 200C, the CPU 11 outputs the video signal from the video signal processing circuit 24A to the wireless communication circuit 25A, and outputs the 5V-pulse signal from the 5V-pulse signal generation circuit 22, the ACK signal, and the HPD pulse signal generation request signal to the wireless communication circuit 27A.

In addition, in the adapter apparatus 200C, the wireless communication circuit 27A digitally modulates a radio carrier wave into radio signals using a predetermined digital modulation method according to the inputted 5V-pulse signal, ACK signal, and HDP pulse signal generation request signal, executes a high frequency signal processing such as high frequency conversion on the radio signals, and wirelessly transmits the processed radio signals to the adapter apparatus 300C via an antenna 26 using a first radio channel. Further, the wireless communication circuit 27A executes a high frequency signal processing such as low frequency conversion and high frequency amplification on a radio signal received via the antenna 28, demodulates the processed radio signal to a baseband signal using a predetermined digital demodulation method, converts the baseband signal into the HPD pulse signal or an ACK signal, and outputs the HPD pulse signal or the ACK signal to the CPU 11.

In the adapter apparatus 300C, the CPU 51 outputs the HPD pulse signal from the HPD pulse signal generation circuit 73 and the ACK signal to the wireless communication circuit 57A. The wireless communication circuit 57A digitally modulates a radio carrier wave into radio signals using a predetermined digital modulation method according to the inputted HPD pulse signal and ACK signal, executes a high frequency signal processing such as high frequency conversion and high frequency amplification on the radio signals, and wirelessly transmits the processed radio signals to the adapter apparatus 200C via the antenna 58 using a second radio channel whose frequency is different from that of the first radio channel. Further, the wireless communication circuit 57A executes a high frequency signal processing such as low frequency conversion and high frequency amplification on the radio signal received via the antenna 58, demodulates the processed radio signal to a baseband signal using a predetermined digital demodulation method, converts the baseband signal into the 5V-pulse signal, the ACK signal or the HPD pulse generation request signal, and outputs the 5V-pulse signal, the ACK signal or the HPD pulse generation request signal to the CPU 11.

The wireless transmission system according to the fourth preferred embodiment exhibits the advantages similar to those of the wireless transmission system according to the third preferred embodiment. In addition, the radio video signal is wirelessly transmitted via the antennas 26 and 56 using the first radio channel, while the radio signals including the audio signal, the 5V-pulse signal, the HPD pulse signal, the ACK signal, and the HPD pulse generation request signal, respectively, are wirelessly transmitted via the antennas 28 and 58 using the second radio channel. Accordingly, as compared with the wireless transmission system according to the third preferred embodiment, the wireless transmission system according to the present preferred embodiment can wirelessly transmit the radio video signal via the antennas 26 and 56, using a transmission path having a larger transmission capacity.

In the third and fourth preferred embodiments, the DVD player 100 may be connected to the adapter apparatus 200B or 200C using a well-known conversion connector for connecting the DVI terminal to the HDMI terminal. In addition, the DVD player 100A may be connected to the adapter apparatus 200 or 200A using the conversion connector. Further, the PDP apparatus 400 may be connected to the adapter apparatus 300B or 300C. Further, the PDP apparatus 400A may be connected to the adapter apparatus 300 or 300A.

In each of the above-stated preferred embodiments, the adapter apparatus 200 or 200A is an external apparatus of the DVD player 100. However, the present invention is not limited to this. The adapter apparatus 200 or 200A may be included in the DVD player 100. Further, in each of the above-stated preferred embodiments, the adapter apparatus 300 or 300A is an external apparatus of the PDP apparatus 400. However, the present invention is not limited to this. The adapter apparatus 300 or 300A may be included in the PDP apparatus 400. Further, the adapter apparatus 200B or 200C is an external apparatus of the DVD player 100A. However, the present invention is not limited to this. The adapter apparatus 200B or 200C may be included in the DVD player 100A. Further, in each of the above-stated preferred embodiments, the adapter apparatus 300B or 300C is an external apparatus of the PDP apparatus 400A. However, the present invention is not limited to this. The adapter apparatus 300B or 300C may be included in the PDP apparatus 400A.

### INDUSTRIAL APPLICABILITY

As described so far in detail, the first wireless communication apparatus according to the first aspect of the present invention includes first wireless communication means and first control means. The first wireless communication means wirelessly transmits a first signal including at least a video signal received from a signal source apparatus to a second wireless communication apparatus as a first radio signal, and receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus. Accordingly, the first wireless communication apparatus can wirelessly transmit the first signal generated by the signal source apparatus, while wirelessly receiving the first initialization signal and outputting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus.

The second wireless communication apparatus according to the second aspect of the present invention includes second wireless communication means and second control means. The second wireless communication means receives a first radio signal including a first signal from the first wireless communication apparatus, and wirelessly transmits the first initialization signal to the first wireless communication apparatus as a second radio signal. The second control means controls a signal source apparatus connected to the first wireless communication apparatus to execute a predetermined first initialization processing, by controlling the second wireless communication means to wirelessly transmit the first initialization signal to the first wireless communication apparatus as the second radio signal. Accordingly, the second wireless communication apparatus can receive the first signal from the first wireless communication apparatus, while wirelessly receiving the first initialization signal to the first wireless communication apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal sink apparatus connected to the second wireless communication apparatus.

The first wireless communication apparatus according to the third aspect of the present invention includes first wireless communication means, second wireless communication means, and first control means. The first wireless communication means wirelessly transmits a first signal including at least a video signal received from a signal source apparatus, to the second wireless communication apparatus as a first radio signal. The second wireless communication means receives a second radio signal including the first initialization signal from the second wireless communication apparatus. The first control means controls the signal source apparatus to execute a predetermined first initialization processing, by converting the second radio signal into the first initialization signal and outputting the first initialization signal to the signal source apparatus. Accordingly, the first wireless communication apparatus can wirelessly transmit the first signal generated by the signal source apparatus, while wirelessly receiving the first initialization signal and outputting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus.

The second wireless communication apparatus according to the fourth aspect of the present invention includes third wireless communication means, fourth wireless communication means, and second control means. The third wireless communication means receives a first radio signal including the first signal from the first wireless communication apparatus. The fourth wireless communication means wirelessly transmits the first initialization signal to the first wireless communication apparatus as a second radio signal.

The second control means controls a signal source apparatus connected to the first wireless communication apparatus to execute a predetermined first initialization processing, by controlling the fourth wireless communication means to wirelessly transmit the first initialization signal to the first wireless communication apparatus as the second radio signal. Accordingly, the second wireless communication apparatus can receive the first signal from the first wireless communication apparatus, while wirelessly receiving the first initialization signal to the first wireless communication apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal sink apparatus connected to the second wireless communication apparatus.

The wireless transmission system according to the fifth aspect of the invention includes the first wireless communication apparatus according to the first aspect of the invention, and the second wireless communication apparatus according to the second aspect of the invention. Accordingly, by connecting the first wireless communication apparatus to the signal source apparatus, and connecting the second wireless communication apparatus to the signal sink apparatus, it is possible to wirelessly transmit the first signal including at least the video signal generated by the signal sink apparatus to the signal sink apparatus, while wirelessly transmitting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus and installation location of the signal sink apparatus connected to the second wireless communication apparatus.

The wireless transmission system according to the sixth aspect of the invention includes the first wireless communication apparatus according to the third aspect of the invention, and the second wireless communication apparatus according to the fourth aspect of the invention. Accordingly, by connecting the first wireless communication apparatus to the signal source apparatus, and connecting the second wireless communication apparatus to the signal sink apparatus, it is possible to wirelessly transmit the first signal including at least the video signal generated by the signal sink apparatus to the signal sink apparatus, while wirelessly transmitting the first initialization signal to the signal source apparatus. Namely, by connecting the signal source apparatus and the signal sink apparatus to each other via a wireless transmission path, the connection can be realized without using any cable and simplified as compared with the prior arts. This leads to enhanced flexibility of the installation location of the signal source apparatus connected to the first wireless communication apparatus and installation location of the signal sink apparatus connected to the second wireless communication apparatus.

1-30. (canceled)

31. A wireless communication apparatus of a first wireless communication apparatus for transmitting a first signal including at least a video signal received from a signal source apparatus, and for receiving a second signal including a first initialization signal, said wireless communication apparatus comprising:
a first wireless communication unit for wirelessly transmitting the first signal to a second wireless communication apparatus as a first radio signal, and for receiving a second radio signal including the first initialization signal from the second wireless communication apparatus; and
a first controller for controlling said signal source apparatus to execute a predetermined first initialization processing, by converting the second radio signal into the first initialization signal and outputting the first initialization signal to said signal source apparatus.

32. The wireless communication apparatus as claimed in claim 31,
wherein, upon detecting a communication failure between said first wireless communication apparatus and said second wireless communication apparatus, said first controller generates a request signal for requesting generation of the second radio signal including the first initialization signal, and controls said first wireless communication unit to wirelessly transmit the request signal to said second wireless communication apparatus.

33. The wireless communication apparatus as claimed in claim 32,
wherein said first controller controls a signal sink apparatus connected to said second wireless communication apparatus to execute a predetermined second initialization processing, by controlling said first wireless communication unit to wirelessly transmit a third radio signal including a second initialization signal to said second wireless communication apparatus.

34. The wireless communication apparatus as claimed in claim 33,
wherein said first controller outputs the first initialization signal to said signal source apparatus after controlling said first wireless communication unit to wirelessly transmit the third radio signal to said second wireless communication apparatus.

35. The wireless communication apparatus as claimed in claim 31,
wherein the first signal includes an audio signal in addition to the video signal, and
wherein the video signal, the audio signal, the first initialization signal, and transmission procedures therefor are compliant with an HDMI (High Definition Multimedia Interface) standard.

36. The wireless communication apparatus as claimed in claim 31,
wherein the video signal, the first initialization signal, and transmission procedures therefor are compliant with a DVI (Digital Visual Interface) standard.

37. A wireless communication apparatus of a second wireless communication apparatus for receiving a first signal including at least a video signal, and for transmitting a second signal including a first initialization signal, said wireless communication apparatus comprising:
a second wireless communication unit for receiving a first radio signal including the first signal from a first wireless communication apparatus, and for wirelessly transmitting the first initialization signal to said first wireless communication apparatus as a second radio signal; and
a second controller for controlling a signal source apparatus connected to said first wireless communication apparatus to execute a predetermined first initialization processing, by controlling said second wireless communication unit to wirelessly transmit the first initialization signal to said first wireless communication apparatus as the second radio signal.

38. The wireless communication apparatus as claimed in claim 37,
wherein, upon detecting a communication failure between said first wireless communication apparatus and said second wireless communication apparatus, said second controller controls said second wireless communication unit to wirelessly transmit the first initialization signal to said first wireless communication apparatus as the second radio signal.

39. The wireless communication apparatus as claimed in claim 38,
wherein said second wireless communication apparatus is connected to a signal sink apparatus, and
wherein, upon detecting the communication failure between said first wireless communication apparatus and said second wireless communication apparatus, said second controller generates a non-image silent signal having predetermined specifications and outputs the non-image silent signal to said signal sink apparatus.

40. The wireless communication apparatus as claimed in claim 37,
wherein, in response to a request signal transmitted from said first wireless communication apparatus for requesting generation of the second radio signal including the first initialization signal, said second controller controls said second wireless communication unit to wirelessly transmit the first initialization signal to said first wireless communication apparatus as the second radio signal.

41. The wireless communication apparatus as claimed in claim 37,
wherein said second wireless communication apparatus is connected to a signal sink apparatus,
wherein said second wireless communication apparatus receives a third radio signal including a second initialization signal from said first wireless communication apparatus, and
wherein said second controller controls said signal sink apparatus to execute a predetermined second initialization processing, by converting the third radio signal into the second initialization signal and outputting the second initialization signal to said signal sink apparatus.

42. The wireless communication apparatus as claimed in claim 41,
wherein said second controller controls said second wireless communication unit to wirelessly transmit the second radio signal including the first initialization signal to said first wireless communication apparatus after outputting the second initialization signal to said signal sink apparatus.

43. The wireless communication apparatus as claimed in claim 37,
wherein the first signal includes an audio signal in addition to the video signal, and
wherein the video signal, the audio signal, the first initialization signal, and transmission procedures therefor are compliant with an HDMI (High Definition Multimedia Interface) standard.

44. The wireless communication apparatus as claimed in claim 37,
wherein the video signal, the first initialization signal, and transmission procedures therefor are compliant with a DVI (Digital Visual Interface) standard.

45. A wireless communication apparatus of a first wireless communication apparatus for transmitting a first signal including at least a video signal received from a signal source apparatus, and for receiving a second signal including a first initialization signal, said wireless communication apparatus comprising:
a first wireless communication unit for wirelessly transmitting the first signal to a second wireless communication apparatus as a first radio signal,
a second wireless communication unit for receiving a second radio signal including the first initialization signal from said second wireless communication apparatus; and
a first controller for controlling said signal source apparatus to execute a predetermined first initialization processing, by converting the second radio signal into the first initialization signal and outputting the first initialization signal to said signal source apparatus.

46. The wireless communication apparatus as claimed in claim 45,
wherein, upon detecting a communication failure between said first wireless communication apparatus and said second wireless communication apparatus, said first controller generates a request signal for requesting generation of the second radio signal including the first initialization signal and controls said second wireless communication unit to wirelessly transmit the request signal to said second wireless communication apparatus.

47. The wireless communication apparatus as claimed in claim 46,
wherein said first controller controls a signal sink apparatus connected to said second wireless communication apparatus to execute a predetermined second initialization processing, by controlling said second wireless communication unit to wirelessly transmit a third radio signal including a second initialization signal to said second wireless communication apparatus.

48. The wireless communication apparatus as claimed in claim 47,
wherein said first controller outputs the first initialization signal to said signal source apparatus after controlling said second wireless communication unit to wirelessly transmit the third radio signal to said second wireless communication apparatus.

49. The wireless communication apparatus as claimed in claim 45,
wherein the first signal includes an audio signal in addition to the video signal, and
wherein the video signal, the audio signal, the first initialization signal, and transmission procedures therefor are compliant with an HDMI (High Definition Multimedia Interface) standard.

50. The wireless communication apparatus as claimed in claim 45,
wherein the video signal, the first initialization signal, and transmission procedures therefor are compliant with a DVI (Digital Visual Interface) standard.

51. A wireless communication apparatus of a second wireless communication apparatus for receiving a first signal including at least a video signal, and for transmitting a second signal including a first initialization signal, said wireless communication apparatus comprising:
a third wireless communication unit for receiving a first radio signal including the first signal from a first wireless communication apparatus,
a fourth wireless communication unit for wirelessly transmitting the first initialization signal to said first wireless communication apparatus as a second radio signal; and
a second controller for controlling a signal source apparatus connected to said first wireless communication apparatus to execute a predetermined first initialization processing, by controlling said fourth wireless communication unit to wirelessly transmit the first initialization signal to said first wireless communication apparatus as the second radio signal.

52. The wireless communication apparatus as claimed in claim 51,
wherein, upon detecting a communication failure between said first wireless communication apparatus and said second wireless communication apparatus, said second controller controls said fourth wireless communication unit to wirelessly transmit the first initialization signal to said first wireless communication apparatus as the second radio signal.

53. The wireless communication apparatus as claimed in claim 52,
wherein said second wireless communication apparatus is connected to a signal sink apparatus, and
wherein, upon detecting the communication failure between said first wireless communication apparatus and said second wireless communication apparatus, said second controller generates a non-image silent signal having predetermined specifications and outputs the non-image silent signal to said signal sink apparatus.

54. The wireless communication apparatus as claimed in claim 51,
wherein, in response to a request signal transmitted from said first wireless communication apparatus for requesting generation of the second radio signal including the first initialization signal, said second controller controls said fourth wireless communication unit to wirelessly transmit the first initialization signal to said first wireless communication apparatus as the second radio signal.

55. The wireless communication apparatus as claimed in claim 51,
wherein said second wireless communication apparatus is connected to a signal sink apparatus,
wherein said fourth wireless communication unit receives a third radio signal including a second initialization signal from said first wireless communication apparatus, and
said second controller controls said signal sink apparatus to execute a predetermined second initialization processing, by converting the third radio signal into the second initialization signal and outputting the second initialization signal to said signal sink apparatus.

56. The wireless communication apparatus as claimed in claim 55,
wherein said second controller controls said fourth wireless communication unit to wirelessly transmit the second radio signal including the first initialization signal to said first wireless communication apparatus after outputting the second initialization signal to said signal sink apparatus.

57. The wireless communication apparatus as claimed in claim 51,
wherein the first signal includes an audio signal in addition to the video signal, and
wherein the video signal, the audio signal, the first initialization signal, and transmission procedures therefor are compliant with an HDMI (High Definition Multimedia Interface) standard.

58. The wireless communication apparatus as claimed in claim 51,
wherein the video signal, the first initialization signal, and transmission procedures therefor are compliant with a DVI (Digital Visual Interface) standard.

59. A wireless transmission system comprising:
a first wireless communication apparatus for transmitting a first signal including at least a video signal received from a signal source apparatus, and for receiving a second signal including a first initialization signal; and
a second wireless communication apparatus for receiving the first signal, and for transmitting the second signal including the first initialization signal,
wherein said first wireless communication apparatus comprises:
a first wireless communication unit for wirelessly transmitting the first signal to said second wireless communication apparatus as a first radio signal, and for receiving a second radio signal including the first initialization signal from the second wireless communication apparatus; and
a first controller for controlling said signal source apparatus to execute a predetermined first initialization processing, by converting the second radio signal into the first initialization signal and outputting the first initialization signal to said signal source apparatus, and
wherein said second wireless communication apparatus comprises:
a second wireless communication unit for receiving the first radio signal including the first signal from said first wireless communication apparatus, and for wirelessly transmitting the first initialization signal to said first wireless communication apparatus as the second radio signal; and
a second controller for controlling said signal source apparatus connected to said first wireless communication apparatus to execute a predetermined first initialization processing, by controlling said second wireless communication unit to wirelessly transmit the first initialization signal to said first wireless communication apparatus as the second radio signal.

60. A wireless transmission system comprising:
a first wireless communication apparatus for transmitting a first signal including at least a video signal received from a signal source apparatus, and for receiving a second signal including a first initialization signal; and
a second wireless communication apparatus for receiving the first signal, and for transmitting a second signal including the first initialization signal,
wherein said first wireless communication apparatus comprises:
a first wireless communication unit for wirelessly transmitting the first signal to a second wireless communication apparatus as a first radio signal,
a second wireless communication unit for receiving a second radio signal including the first initialization signal from said second wireless communication apparatus; and
a first controller for controlling said signal source apparatus to execute a predetermined first initialization processing, by converting the second radio signal into the first initialization signal and outputting the first initialization signal to said signal source apparatus, and
wherein said second wireless communication apparatus comprises:
a third wireless communication unit for receiving the first radio signal including the first signal from said first wireless communication apparatus,
a fourth wireless communication unit for wirelessly transmitting the first initialization signal to said first wireless communication apparatus as the second radio signal; and
a second controller for controlling said signal source apparatus connected to said first wireless communication apparatus to execute a predetermined first initialization processing, by controlling said fourth wireless communication unit to wirelessly transmit the first initialization signal to said first wireless communication apparatus as the second radio signal.

61. The wireless communication apparatus as claimed in claim 31,
wherein the first initialization signal is an HPD (Hot Plug Detect) signal defined by one of the HDMI standard and DVI standard.

62. The wireless communication apparatus as claimed in claim 33,
wherein the second initialization signal is a 5V-voltage signal defined by one of the HDMI standard and DVI standard.
